(19) United States
(12) Patent Application Publication
(10) Pub. No.: US 2026/0280240 A1
(43) Pub. Date: Sep. 17, 2026

(54) CIRCUIT BREAKER GUIDE RAIL AND DISTRIBUTION BOARD INCLUDING SAME

(71) Applicant: LS ELECTRIC CO., LTD., Anyang-si, Gyeonggi-do (KR)

(72) Inventor: Junyoun JO, Anyang-si, Gyeonggi-do (KR)

(21) Appl. No.: 19/469,121

(22) PCT Filed: Feb. 6, 2024
(86) PCT No.: PCT/KR2024/001746

§ 371 Date: Sep. 25, 2025

(30) Foreign Application Priority Data
Apr. 4, 2023 (KR) 10-2023-0044327

(51) Int. Cl. H02B 1/32; H02B 1/04

(52) U.S. Cl. CPC H02B 1/32; H02B 1/04

(57) ABSTRACT

The present disclosure relates to a circuit breaker guide rail and a distribution board including same. The circuit breaker guide rail of the present disclosure is provided at the front of a circuit breaker compartment in which a circuit breaker is accommodated, so as to guide the movement of the circuit breaker, and comprises: a guide rail body having a rear end coupled to the circuit breaker compartment; and an interlock device including an interlock body provided at the front end of the guide rail body and arranged at any one of a permitted location at which movement of the circuit breaker placed on the upper surface of the guide rail body is permitted and an inhibition location at which movement of the circuit breaker is inhibited. Therefore, the circuit breaker can be easily moved, and the circuit breaker can be prevented from falling.

### CROSS-REFERENCE TO RELATED APPLICATIONS

This application is the National Stage filing under 35 U.S.C. 371 of International Application No. PCT/KR2024/001746, filed on Feb. 6, 2024, which claims the benefit of earlier filing date and right of priority to Korean Application No. 10-2023-0044327, filed on Apr. 4, 2023, the contents of which are all hereby incorporated by reference herein in their entirety.

### FIELD

The present disclosure relates to a circuit breaker guide rail and a distribution board including the same.

### BACKGROUND

As is known, a distribution board is installed at a power plant, substation, or electrical facility for the purpose of monitoring, controlling, and/or protecting an electrical system.

The distribution board is provided with electrical devices such as a circuit breaker, a stabilizer, an instrument, an indicator light, and a relay inside to facilitate the opening and closing of an electric circuit and the control of a device.

FIG. 1 is a drawing showing an inside of a conventional distribution board, FIG. 2 is a drawing showing a guide rail coupled to an enclosure of FIG. 1, FIG. 3 is a side view showing a state prior to placing a circuit breaker on the guide rail of FIG. 2, FIG. 4 is a drawing showing a state subsequent to placing the circuit breaker on the guide rail of FIG. 3, and FIG. 5 is a side view of FIG. 4.

As shown in FIGS. 1 to 5, a conventional distribution board 10 includes an enclosure 20 having an accommodation space formed inside and a circuit breaker 30 stored inside the enclosure 20 in a withdrawable manner.

The enclosure 20 has an approximately rectangular parallelepiped shape.

An accommodation space having an open front area is formed inside the enclosure 20.

Although not shown in the drawing, a front opening of the enclosure 20 is provided with a door that opens and closes the front opening.

An external terminal 23 is provided in an internal rear area of the enclosure 20.

The external terminal 23 is provided with an upper terminal 24 and a lower terminal 25 spaced apart in a top-down direction.

The upper terminal 24 and lower terminal 25 are respectively configured in three pieces spaced apart horizontally to correspond to each phase (R phase, S phase, T phase) of a three-phase AC power source.

A circuit breaker compartment 22 is formed in an internal front area of the enclosure 20 so as to accommodate a circuit breaker 30.

The circuit breaker 30 is configured to protect, when a dangerous situation such as a short circuit or overcurrent occurs, a power system by interrupting a circuit.

The circuit breaker 30 is configured to include a main circuit part 31, a driving part 35, an operating part 36, and a transfer part 37.

The main circuit part 31 is configured to include a vacuum interrupter 32 having a fixed contactor and a movable contactor provided inside a vacuum container, and an upper terminal 33 and a lower terminal 34 connected to the fixed contactor and the movable contactor, respectively.

The driving part 35 is configured to provide a driving force so as to allow the movable contactor to approach and separate from the fixed contactor. The driving part 35, although not specifically shown in the drawing, is configured to include an actuator that generates a driving force and a plurality of links that are connected to allow a relative movement to one another.

The driving part 35 is provided at a front of the main circuit part 31, and the operating part 36 for inputting an operating (control) signal to the driving part 35 is provided in front of the driving part 35.

The transfer part 37 is provided on a lower side so as to transfer the main circuit part 31, the driving part 35, and the operating part 36.

The transfer part 37 is provided with a rectangular plate-shaped bogie 38 and a plurality of wheels 39 provided on a lower side of the bogie 38.

The plurality of wheels 39 are respectively provided on both front and rear sides of the bogie 38.

The plurality of wheels 39 consist of four.

A guide rail 50 that guides the circuit breaker 30 is provided at a front of the enclosure 20.

The guide rails 50 are configured as a pair corresponding to the wheels 39 of the circuit breaker 30.

The guide rails 50 are respectively coupled to left and right sides of a front end of the enclosure 20.

Thereby, the circuit breaker 30 can be moved in a front-rear direction of the enclosure 20 along the guide rail 50.

The guide rail 50 is provided with a locking projection 51 to inhibit the circuit breaker 30 placed on the guide rail 50 from being detached outward from the guide rail 50 and causing the circuit breaker 30 to plunge or fall.

The locking projection 51 is formed to protrude upward at a front end of the guide rail 50.

The locking projection 51 can be formed to be integrally fixed to an upper surface of the guide rail 50, thereby inhibiting, when the circuit breaker 30 placed on the upper surface of the guide rail 50 moves to the front end of the guide rail 50, forward movement of the circuit breaker 30.

Meanwhile, the circuit breaker 30 is moved by a lifter 60 that can raise and lower the circuit breaker 30, as shown in FIG. 3.

The lifter 60 is configured to include a frame 61, a lifting part 63 provided to be raised or lowered on an upper surface of the frame 61, and a wheel 65 provided to be driven below the frame 61.

The lifter 60 is configured to raise and lower the circuit breaker 30 to a height corresponding to the guide rail 50.

With this configuration, when the circuit breaker 30 is to be put into the circuit breaker compartment 22, a rear end of the guide rail 50 is coupled to a front end of the enclosure 20 of the distribution board 10.

Then, the circuit breaker 30 to be put thereinto is transferred to a front end of the guide rail 50 using the lifter 60.

One end (fore end) of the lifter is located to correspond to the front end of the guide rail 50.

However, in the conventional distribution board 10, the locking projection 51 protrudes upward from the front end of the guide rail 50 to inhibit the circuit breaker 30 placed on the upper surface of the guide rail 50 from being detached from the front end of the guide rail 50, and when the circuit breaker 30 is moved by pushing it toward an upper side of the guide rail 50, there is a problem in that the circuit breaker 30 and the locking projection 51 come into contact with each other, making it difficult to move the circuit breaker 30.

In particular, since the circuit breakers 30 weighs several hundred kilograms, it is difficult to lift and move the circuit breaker 30 with a small number of people, so there is a problem in that a relatively large number of people are put in or equipment has to be put in.

### SUMMARY

Accordingly, an aspect of the present disclosure is to provide a circuit breaker guide rail that can facilitate movement of a circuit breaker and prevent the circuit breaker from falling, and a distribution board including the same.

In addition, another object of the present disclosure is to provide a circuit breaker guide rail that can inhibit detachment of a circuit breaker by gravity, and a distribution board including the same.

In addition, another aspect of the present disclosure is to provide a circuit breaker guide rail that can permit movement of a circuit breaker during coupling of a lifter and inhibit detachment of the circuit breaker during separation of the lifter, and a distribution board including the same.

In order to solve the foregoing problems, a circuit breaker guide rail according to the present disclosure has a technical feature of including an interlock device that permits movement of a circuit breaker toward an upper surface of the guide rail and inhibits detachment of the circuit breaker from the upper surface of the guide rail.

Specifically, an interlock device including an interlock body arranged at either a permitted location that permits movement of the circuit breaker or an inhibition location that inhibits detachment of the circuit breaker can be provided on the guide rail, thereby allowing the circuit breaker to be easily moved to the upper surface of the guide rail, and inhibiting the circuit breaker from being detached from the upper surface of the guide rail.

Thereby, the circuit breaker can be inhibited from being detached from the upper surface of the guide rail and causing the circuit breaker to fall (plunge, overturn).

A circuit breaker guide rail according to one embodiment of the present disclosure, which is provided at a front of a circuit breaker compartment in which a circuit breaker is accommodated to guide movement of the circuit breaker, is configured to include: a guide rail body having a rear end coupled to the circuit breaker compartment; and an interlock device provided at a front end of the guide rail body to control the movement of the circuit breaker placed on an upper surface of the guide rail body, wherein the interlock device includes an interlock body arranged at either a permitted location that permits movement of the circuit breaker placed on the upper surface of the guide rail body or an inhibition location that inhibits the movement of the circuit breaker.

Thereby, the circuit breaker can be easily moved to the upper surface of the guide rail, and the circuit breaker can be inhibited from being detached from the upper surface of the guide rail.

According to one embodiment of the present disclosure, the guide rail body is provided with a rotation shaft that rotatably supports the interlock body.

Thereby, the interlock body can be rotated between the permitted location and the inhibition location around the rotation shaft.

According to one embodiment of the present disclosure, a support part is provided on one side of the rotation shaft of the guide rail body to support the interlock body in contact with the interlock body when the interlock body is at the inhibition location.

Here, the support part is formed to protrude along a thickness direction from the guide rail body.

According to one embodiment of the present disclosure, the guide rail body includes an inner plate and an outer plate that are in contact with each other in a thickness direction, the inner plate protrudes upward from the outer plate, and the interlock body is formed to protrude upward from the inner plate when at the inhibition location.

Thereby, the circuit breaker moving along the inner plate and the interlock body come into contact, thereby inhibiting the movement of the circuit breaker.

In one embodiment of the present disclosure, the circuit breaker is provided with a plurality of wheels, the plurality of wheels each include an inner wheel and an outer wheel spaced apart along an axial direction, the inner wheel is arranged on an inner side of the inner plate, and the outer wheel is arranged on an outer side of the inner plate.

Thereby, each of the plurality of wheels can be inhibited from moving inward and/or outward of the inner plate along an axial direction.

In one embodiment of the present disclosure, a connection part is provided between the inner wheel and the outer wheel, the connection part is in rolling contact with an upper surface of the inner plate, the outer wheel is in rolling contact with an upper surface of the outer plate, and the interlock body is arranged to be in contact with the inner wheel.

Thereby, a load of the circuit breaker can be distributed and supported by the inner plate and the outer plate.

Additionally, movement of the wheel (inner wheel) of the circuit breaker can be inhibited by the interlock body.

In one embodiment of the present disclosure, the interlock body is configured to include an inhibition part protruding upward from the guide rail body when at the inhibition location to inhibit the movement of the circuit breaker.

Thereby, the circuit breaker can be inhibited from being detached from a front end of the guide rail body.

In one embodiment of the present disclosure, the interlock body is configured to include an expansion part that expands to a larger size compared to the inhibition part so as to be moved to the inhibition location by gravity.

Thereby, the interlock body can be rotated to the inhibition location by gravity (its own weight).

According to this configuration, while the circuit breaker is placed on an upper surface of the guide rail body, the interlock body can be rotated to the inhibition location by its own weight without any special operation, thereby inhibiting the circuit breaker from being detached from the guide rail body.

In one embodiment of the present disclosure, the interlock device is configured to further include an elastic pressing part that elastically presses the interlock body so as to rotate the interlock body to the inhibition location.

Thereby, the interlock body can be rotated to the inhibition location by an elastic force of the elastic member.

Thereby, the interlock body can always be located at the inhibition location except when the circuit breaker moves to an upper surface of the guide rail, thereby improving the operational reliability of the interlock device (interlock body).

Here, the elastic member can be implemented as a spring member that stretches in conjunction with the rotation of the interlock body.

In one embodiment of the present disclosure, the guide rail body is provided with an interlock body support part that accommodates and supports the interlock body, and when at the inhibition location, the interlock body is configured to include: a locking part that is caught and maintained on an upper surface of the interlock body support part; a first body protruding from the locking part, and protruding upward from the guide rail body to inhibit movement of the circuit breaker; and a second body protruding from the locking part to be inserted into the interlock body support part.

Thereby, the second body can be coupled to the interlock body support part so as to inhibit forward detachment of the circuit breaker by the first body.

In one embodiment of the present disclosure, the interlock body is formed such that, when at the permitted location, the first body is inserted into the interlock body support part, and the second body protrudes from an upper side of the locking part, but is spaced downward from an upper surface of the guide rail body so as to allow a wheel of the circuit breaker to pass therethrough.

Thereby, the first body can be coupled to the interlock body support part so as to allow the circuit breaker to be smoothly moved to the upper surface of the guide rail body.

Meanwhile, according to another field of the present disclosure, there is provided a circuit breaker guide rail provided at a front of a circuit breaker compartment in which a circuit breaker is accommodated to guide movement of the circuit breaker includes: a guide rail body having a rear end coupled to the circuit breaker compartment; and an interlock device having an interlock body provided at a front end of the guide rail body and arranged at either a permitted location that permits the movement of the circuit breaker placed on an upper surface of the guide rail body and an inhibition location that inhibits the movement of the circuit breaker, wherein the interlock body includes: an inhibition part that protrudes upward from the guide rail body when at the inhibition location to inhibit movement of the circuit breaker; and an expansion part that expands to a larger size compared to the inhibition part so as to be rotated to the inhibition location by gravity.

Thereby, the circuit breaker can be easily moved to the upper surface of the guide rail body, and the circuit breaker that has moved to the upper surface of the guide rail body can be inhibited from being detached from the upper surface of the guide rail body by the interlock body moved to the inhibition location by its own weight.

In one embodiment of the present disclosure, the guide rail body includes an inner plate and an outer plate that are in contact with each other in a thickness direction, the inner plate protrudes upward from the outer plate, and the inhibition part is configured to include a linear section arranged parallel to the upper surface of the inner plate when at the permitted location.

Thereby, unnecessary contact between the circuit breaker and the interlock body at the permitted location can be inhibited to smoothly perform movement of the circuit breaker.

In one embodiment of the present disclosure, the linear section is arranged to form an acute angle with respect to the upper surface of the inner plate at the inhibition location, and the inhibition part is formed to be in contact with a point greater than half a height of the wheel of the circuit breaker.

Thereby, a rotation range of the interlock body can be reduced, and the wheel of the circuit breaker placed on the upper surface of the guide rail can be brought into smooth contact with the inhibition part so as to allow the interlock body to be pressed by the wheel to rotate smoothly to the inhibition location and effectively inhibit the detachment of the circuit breaker.

In one embodiment of the present disclosure, a lifter coupling part is formed in the guide rail body into which a lifter that raises and lowers the circuit breaker is inserted and coupled.

Thereby, the lifter and the guide rail body can be coupled to at a preset location, thereby allowing the circuit breaker of the lifter to smoothly move to the upper surface of the guide rail.

In one embodiment of the present disclosure, the lifter coupling part is formed to be cut from the front end of the guide rail body toward the rear end, and the interlock body is configured to rotate to the permitted location by being pressed by the lifter when the lifter is coupled to the lifter coupling part.

Thereby, a fore end of the lifter, in a process of being inserted into a front end of the lifter coupling part to move toward a rear end, comes into contact with the interlock body to press the interlock body rearward, thereby allowing the interlock body to rotate from the inhibition location to the permitted location.

Thereby, the circuit breaker in the lifter can move smoothly to the upper surface of the guide rail body without interference by the interlock body.

In addition, according to another field of the present disclosure, there is provided a circuit breaker guide rail provided at a front of a circuit breaker compartment in which a circuit breaker is accommodated to guide movement of the circuit breaker includes: a guide rail body having a rear end coupled to the circuit breaker compartment; and an interlock device having an interlock body provided at a front end of the guide rail body and arranged at either a permitted location that permits the movement of the circuit breaker placed on an upper surface of the guide rail body and an inhibition location that inhibits the movement of the circuit breaker, wherein a lifter coupling part to which a lifter that raises and lowers the circuit breaker is coupled is formed on the guide rail body, the interlock body includes: an inhibition part which protrudes upward from the guide rail body when at the inhibition location to inhibit the movement of the circuit breaker, and the interlock body is pressed by the lifter to rotate to the permitted location.

Thereby, during coupling of the lifter, the interlock body can move to the permitted location so as to allow the circuit breaker of the lifter to move smoothly to the guide rail.

In addition, according to still another field of the present disclosure, there is provided a distribution board including: a circuit breaker; an enclosure provided with a circuit breaker compartment inside so as to accommodate the circuit breaker; and a guide rail provided at a front of the enclosure to guide the movement of the circuit breaker, wherein the guide rail includes: a guide rail body having a rear end coupled to the circuit breaker compartment and extending to a front of the enclosure; and an interlock device including an interlock body provided at a front end of the guide rail body, and arranged at either a permitted location that permits movement of the circuit breaker placed on an upper surface of the guide rail body and an inhibition location that inhibits the movement of the circuit breaker.

Thereby, movement from an outer side of the guide rail to an upper surface of the guide rail can be easily performed, and the circuit breaker on the upper surface of the guide rail can be inhibited from being unexpectedly detached from a front end of the guide rail.

According to one embodiment of the present disclosure, the guide rail body includes: a rotation shaft that rotatably supports the interlock body; and a support part in contact with the interlock body to support the interlock body when the interlock body is at the inhibition location.

Thereby, the interlock body can be rotated to the permitted location and the inhibition location, respectively, around the rotation shaft, and the rotation can be inhibited by the support part at the inhibition location, thereby inhibiting the occurrence of detachment of the circuit breaker.

In one embodiment of the present disclosure, the guide rail body includes an inner plate and an outer plate that are in contact with each other in a thickness direction, the inner plate protrudes upward from the outer plate, the interlock body is formed to protrude upward from the inner plate, the circuit breaker is provided with a plurality of wheels, and each of the plurality of wheels is formed to accommodate an upper end of the inner plate.

Thereby, the occurrence of lateral movement (displacement) of the circuit breaker can be inhibited.

In one embodiment of the present disclosure, the plurality of wheels each includes an inner wheel and an outer wheel spaced apart along an axial direction, the inner wheel is arranged on an inner side of the inner plate, the outer wheel is arranged on an outer side of the inner plate, and the interlock body is configured to include: an inhibition part that protrudes upward from the guide rail body when at the inhibition location to inhibit movement of the circuit breaker; and an expansion part that is formed to be greatly expanded compared to the inhibition part so as to be moved to the inhibition location by gravity.

Thereby, the circuit breaker can be inhibited from moving inward and/or outward of the inner plate along an axial direction.

In addition, when the circuit breaker is moved to the upper surface of the guide rail body, the interlock body can be moved to the inhibition location by its own weight (gravity), thereby inhibiting the circuit breaker from being detached from the guide rail body without any special operation.

In addition, according to still another field of the present disclosure, there is provided a distribution board including: a circuit breaker; an enclosure provided with a circuit breaker compartment inside so as to accommodate the circuit breaker; and a guide rail provided at a front of the enclosure to guide the movement of the circuit breaker, wherein the guide rail includes: a guide rail body having a rear end coupled to the circuit breaker compartment and extending to a front of the enclosure; and an interlock device including an interlock body provided at a front end of the guide rail body, and arranged at either a permitted location that permits movement of the circuit breaker placed on an upper surface of the guide rail body and an inhibition location that inhibits the movement of the circuit breaker, the guide rail body is provided with a rotation shaft that rotatably supports the interlock body, and the interlock body includes: an inhibition part that protrudes upward from the guide rail body when at the inhibition location to inhibit movement of the circuit breaker; and an expansion part formed to be significantly expanded compared to the inhibition part so as to be moved to the inhibition location by gravity.

Thereby, the circuit breaker can be moved to the upper surface of the guide rail, and then the interlock body can be rotated to the inhibition location by its own weight (gravity) without any additional operation, thereby inhibiting the circuit breaker from being detached from a front end of the guide rail.

In one embodiment of the present disclosure, the circuit breaker is provided with a plurality of wheels, the plurality of wheels each include an inner wheel and an outer wheel, which are spaced apart from each other in an axial direction, and a connection part connecting the inner wheel and the outer wheel, wherein the guide rail body includes an inner plate and an outer plate, which are in contact with each other in a thickness direction, the inner plate protrudes upward from the outer plate, the inner wheel is arranged on an inner side of the inner plate, the outer wheel is arranged on an outer side of the inner plate, an upper end surface of the inner plate is in contact with the connection part, and the outer wheel is formed to be in rolling contact with the outer plate.

Thereby, a load of the circuit breaker can be distributed and supported by the inner plate and the outer plate.

In addition, the inhibition part includes a linear section arranged parallel to the upper surface of the inner plate when at the permitted location, the linear section is arranged to form an acute angle with respect to the upper surface of the inner plate when at the inhibition location, and the inhibition part is formed to be in contact with a point greater than half a height of the wheel of the circuit breaker when at the inhibition location.

Thereby, a rotation range of the interlock body between the permitted location and the inhibition location can be reduced. In addition, a contact between the circuit breaker placed on the upper surface of the guide rail body and the interlock body (inhibition part) can be smoothly performed to effectively inhibit forward detachment of the circuit breaker.

In addition, according to still another field of the present disclosure, there is provided a distribution board including: a circuit breaker; an enclosure provided with a circuit breaker compartment inside so as to accommodate the circuit breaker; a guide rail provided at a front of the enclosure to guide the movement of the circuit breaker; and a lifter arranged at a front of the guide rail to raise and lower the circuit breaker to a height corresponding to the guide rail, wherein the guide rail includes: a guide rail body having a rear end coupled to the circuit breaker compartment and extending to a front of the enclosure; and an interlock body provided at a front end of the guide rail body, and arranged at either a permitted location that permits movement of the circuit breaker placed on an upper surface of the guide rail body and an inhibition location that inhibits the movement of the circuit breaker, the guide rail body is provided with a rotation shaft that rotatably supports the interlock body, the guide rail body is provided with a lifter coupling part to which the lifter is coupled, the interlock body includes an inhibition part that protrudes upward from the guide rail body when at the inhibition location to inhibit movement of the circuit breaker, and the interlock body is pressed by the lifter during coupling of the lifter to rotate to the permitted location.

Thereby, during the coupling of the lifter, the interlock body can be rotated to the permitted location by the lifter so as to allow the circuit breaker of the lifter to be easily moved to the upper surface of the guide rail without interfering with the interlock body.

In one embodiment of the present disclosure, the lifter includes: a lifter body having a plurality of rollers to be driven; and a lifting part provided to be raised and lowered on the lifter body, and the lifting part can include: a base on which the circuit breaker is placed; and a wheel guide part that is coupled to a wheel of the circuit breaker on an upper surface of the base to guide movement of the wheel, and a guide rail body coupling part to which the guide rail body is coupled can be provided on the base.

Thereby, the lifter and the guide rail can be accurately coupled to each other at a preset location.

According to this configuration, the circuit breaker of the lifter can be easily moved to the guide rail.

In one embodiment of the present disclosure, the guide rail body coupling part is arranged at a front of the wheel guide part, the guide rail body coupling part is coupled to the lifter coupling part, and when the guide rail body coupling part and the lifter coupling part are coupled to each other, the wheel guide part can be arranged on the same line as the inner plate.

Thereby, the wheel guide part of the lifter and the guide rail are aligned in a straight line, thereby allowing the circuit breaker of the lifter to move smoothly to the upper surface of the guide rail.

In one embodiment of the present disclosure, a detachment inhibition part is provided on one side of the wheel guide part to cross the wheel guide part and to inhibit the circuit breaker from being unexpectedly detached from the wheel guide part.

Thereby, during the movement of the circuit breaker placed on the wheel guide part of the lifter, the circuit breaker can be inhibited from being unexpected detached from the wheel guide part.

In one embodiment of the present disclosure, the detachment inhibition part includes: a cross pin arranged to cross one end of the wheel guide part; and a cross pin support part that rotatably supports the cross pin, and the wheel guide part is provided with a cross pin accommodation part to accommodate the cross pin.

Thereby, the cross pin is accommodated in the cross pin accommodation part and arranged to cross with respect to the wheel guide part, thereby inhibiting the circuit breaker placed on the wheel guide part from moving along the wheel guide part.

In one embodiment of the present disclosure, the detachment inhibition part is configured to further include a cross pin fixing part that fixes the cross pin so as to allow the cross pin to be maintained in a state of being spaced apart from the wheel guide part.

Thereby, when moving the circuit breaker of the lifter along the guide rail, unnecessary contact between the cross pin and the wheel of the circuit breaker can be inhibited.

In one embodiment of the present disclosure, the cross pin fixing part is configured to include: a rib formed parallel to the wheel guide part; and a cut-out part formed by cutting out the rib so as to accommodate an end of the cross pin.

Thereby, the end of the cross pin spaced apart from the wheel guide part can be accommodated, thereby stably maintaining a state of the cross pin being spaced apart from the wheel guide part.

Meanwhile, according to still another field of the present disclosure, there is provided a distribution board including a circuit breaker; an enclosure provided with a circuit breaker compartment inside so as to accommodate the circuit breaker; and a guide rail provided at a front of the enclosure to guide the movement of the circuit breaker, wherein the guide rail includes: a guide rail body having a rear end coupled to the circuit breaker compartment and extending to a front of the enclosure; and an interlock device including an interlock body provided at a front end of the guide rail body, and arranged at either a permitted location that permits movement of the circuit breaker placed on an upper surface of the guide rail body and an inhibition location that inhibits the movement of the circuit breaker, the guide rail body is provided with an interlock body support part that accommodates and supports the interlock body, and the interlock body includes: a locking part that is caught and maintained on an upper surface of the interlock body support part when at the inhibition location; a first body protruding from the locking part and protruding upward from the guide rail body to inhibit the movement of the circuit breaker; and a second body protruding from the locking part to be inserted into the interlock body support part.

Thereby, the second body of the interlock body can be coupled to the interlock body support part to inhibit detachment of the circuit breaker from the upper surface of the guide rail.

In one embodiment of the present disclosure, the interlock body is formed such that, when at the permitted location, the first body is inserted into the interlock body support part, and the second body protrudes from an upper side of the locking part, but is spaced downward from an upper surface of the guide rail body so as to allow a wheel of the circuit breaker to pass therethrough.

Thereby, the first body can be coupled to the interlock body support part so as to allow the circuit breaker to be smoothly moved to the upper surface of the guide rail.

As described above, according to one embodiment of the present disclosure, an interlock device that controls movement of a circuit breaker placed on an upper surface of a guide rail body can include an interlock body arranged in either a permitted location that permits movement of the circuit breaker placed on the upper surface of the guide rail body or an inhibition location that inhibits the movement, thereby facilitating the movement of the circuit breaker to the upper surface of the guide rail body, and inhibiting the circuit breaker of the guide rail body from being unexpectedly detached from the guide rail body.

In addition, the guide rail body can be provided with a rotation shaft that rotatably supports the interlock body, and a support part in contact with the interlock body to support the interlock body when the interlock body is at the inhibition location on one side of the rotation shaft, thereby allowing the interlock body to rotate between the permitted location and the inhibition location around the rotation shaft, and inhibiting the detachment of the circuit breaker when at the inhibition location.

In addition, the guide rail body can include an inner plate and an outer plate, the circuit breaker can include a plurality of wheels, and the plurality of wheels can include an inner wheel and an outer wheel, but the inner wheel can be arranged on an inner side of the inner plate and the outer wheel can be arranged on an outer side of the inner plate, thereby inhibiting lateral (inward and/or outward) movement of the circuit breaker.

In addition, a connection part can be provided between the inner wheel and the outer wheel, the connection part can be in rolling contact with an upper surface of the inner plate, the outer wheel can be in rolling contact with an upper surface of the outer plate, and the interlock body can be arranged so as to be in contact with the inner wheel, thereby allowing a load of the circuit breaker to be distributed and supported by the inner plate and the outer plate. Additionally, movement of the wheel (inner wheel) of the circuit breaker can be inhibited by the interlock body.

In addition, the interlock body can include an inhibition part protruding upward from the guide rail body and an expansion part that expands to a larger size compared to the inhibition part so that it can be rotated to an inhibition location by gravity, so as to allow the interlock body to be rotated to the inhibition location by gravity without any special operation, and thus the circuit breaker on the upper surface of the guide rail body can be inhibited from being unexpectedly detached from the guide rail body.

In addition, the interlock device can include an elastic pressing part that elastically presses the interlock body to rotate to the inhibition location, thereby improving the operational reliability of the interlock body.

In addition, the inhibition part can include a linear section arranged parallel to the upper surface of the inner plate at the permitted location, thereby inhibiting the occurrence of unnecessary interference between the circuit breaker and the interlock body during the movement of the circuit breaker.

In addition, the linear section can be arranged to form an acute angle with respect to the upper surface of the inner plate at the inhibition location, and the inhibition part can be formed to be in contact with a point greater than half a height of the wheel of the circuit breaker, thereby reducing a rotation range (angle) of the interlock body, and allowing the interlock body to smoothly rotate to the inhibition location when the wheel of the circuit breaker and the interlock body come into contact with each other.

In addition, a lifter coupling part into which a lifter that raises and lowers the circuit breaker is inserted and coupled can be formed in the guide rail body, thereby allowing the lifter and the guide rail to be accurately coupled at a preset location. Thereby, the circuit breaker of the lifter can be moved smoothly along the guide rail.

In addition, the lifter can include a lifter body and an lifting part, and the lifting part can include a base, a wheel guide part, and a guide rail body coupling part to which the guide rail body is coupled, thereby allowing the lifter and the guide rail to be coupled at an accurate location, and allowing the circuit breaker of the wheel guide part to be smoothly moved to the guide rail body.

In addition, a detachment inhibition part can be provided on one side of the wheel guide part of the lifter so as to cross the wheel guide part, thereby inhibiting the circuit breaker from being unexpectedly detached from the wheel guide part when the circuit breaker of the lifter is transported.

In addition, the detachment inhibition part can include a cross pin arranged to cross one end of the wheel guide part and a cross pin fixing part that fixes the cross pin in a state of being spaced apart from the wheel guide part, thereby inhibiting unnecessary contact between the circuit breaker and the cross pin in a process of moving the circuit breaker of the lifter to the guide rail.

### BRIEF DESCRIPTION OF THE DRAWINGS

FIG. 1 is a drawing showing an inside of a conventional distribution board.

FIG. 2 is a drawing showing a guide rail coupled to an enclosure of FIG. 1.

FIG. 3 is a side view showing a state prior to placing a circuit breaker on the guide rail of FIG. 2.

FIG. 4 is a drawing showing a state in which a circuit breaker is placed on the guide rail of FIG. 3.

FIG. 5 is a side view of the circuit breaker of FIG. 4.

FIG. 6 is a perspective view of a distribution board including a circuit breaker guide rail according to one embodiment of the present disclosure.

FIG. 7 is an enlarged view of an interlock device area of FIG. 6.

FIG. 8 is a side view of the distribution board of FIG. 6.

FIG. 9 is a perspective view of the circuit breaker guide rail according to one embodiment of the present disclosure in FIG. 6.

FIG. 10 is a front view of the guide rail of FIG. 9.

FIG. 11 is a plan view of the guide rail of FIG. 9.

FIG. 12 is a left side view of the guide rail of FIG. 9.

FIG. 13 is a drawing showing a state in which the circuit breaker of FIG. 6 is placed on a lifter prior to being moved to the guide rail.

FIG. 14 is a perspective view of the lifter of FIG. 13.

FIG. 15 is an enlarged perspective view of a main part of the lifter of FIG. 14.

FIG. 16 is a drawing showing a state in which a cross pin of FIG. 15 is spaced apart from a wheel guide part.

FIG. 17 is a drawing showing an inhibition location between a wheel of the circuit breaker and an interlock device prior to coupling of the lifter of FIG. 13.

FIG. 18 is a drawing showing a permitted location between the wheel of the circuit breaker and the interlock device during the coupling of the lifter in FIG. 17.

FIG. 19 is a drawing showing an inhibition location between the wheel of the circuit breaker and the interlock device in FIG. 18.

FIG. 20 is a drawing for explaining an operation between the wheel of the circuit breaker and the interlock device in FIG. 19.

FIG. 21 is a drawing showing an interlock device area of a circuit breaker guide rail according to another embodiment of the present disclosure.

FIG. 22 is a drawing showing a permitted location between the wheel of the circuit breaker and the interlock device in FIG. 21.

FIG. 23 is a drawing showing an inhibition location between the wheel of the circuit breaker and the interlock device in FIG. 22.

FIG. 24 is a drawing for explaining an operation between the wheel of the circuit breaker and the interlock device in FIG. 23.

FIG. 25 is a drawing showing an interlock device area of a circuit breaker guide rail according to still another embodiment of the present disclosure.

FIG. 26 is a drawing showing a state prior to coupling of the circuit breaker guide rail and the lifter in FIG. 25.

FIG. 27 is a drawing showing a permitted location between the wheel of the circuit breaker and the interlock device in FIG. 26.

FIG. 28 is a drawing showing an inhibition location between the wheel of the circuit breaker and the interlock device in FIG. 27.

FIG. 29 is a drawing for explaining an operation between the wheel of the circuit breaker and the interlock device in FIG. 28.

FIG. 30 is a perspective view of an interlock device area of a circuit breaker guide rail according to yet still another embodiment of the present disclosure.

FIG. 31 is a drawing showing a state prior to coupling of the circuit breaker guide rail and the lifter of FIG. 30.

FIG. 32 is a drawing showing a permitted location between the wheel of the circuit breaker and the interlock device in FIG. 31.

FIG. 33 is a drawing showing an inhibition location between the wheel of the circuit breaker and the interlock device in FIG. 32.

FIG. 34 is a drawing for explaining an operation between the wheel of the circuit breaker and the interlock device in FIG. 33.

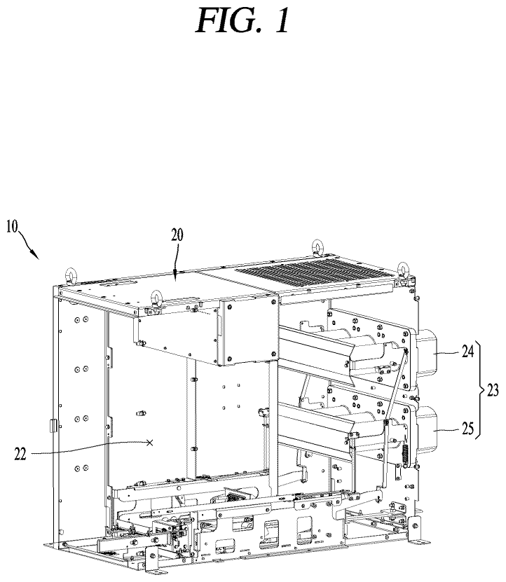

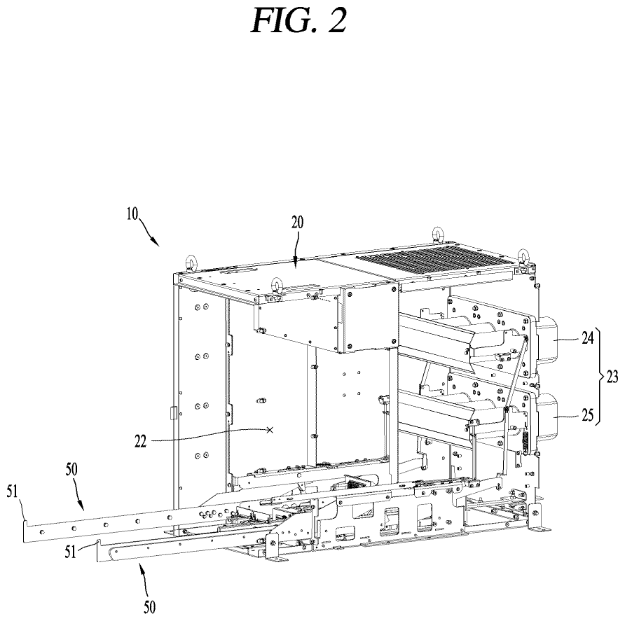

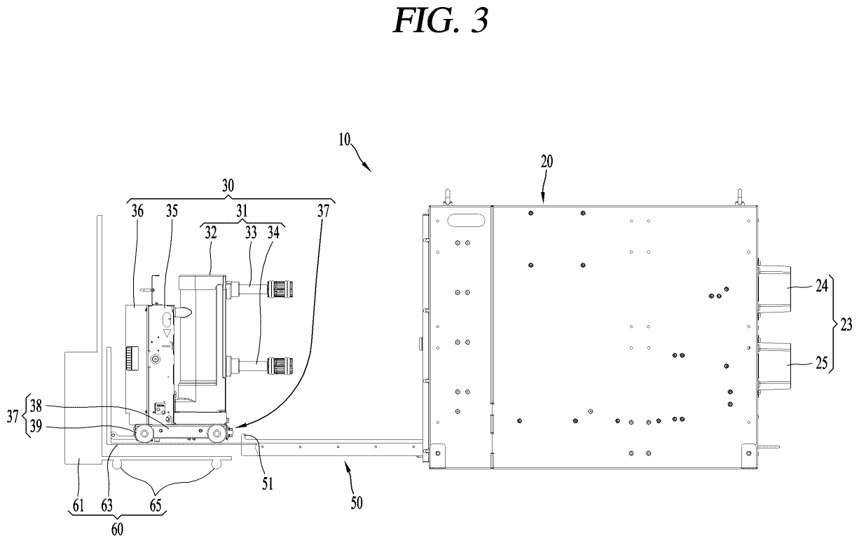

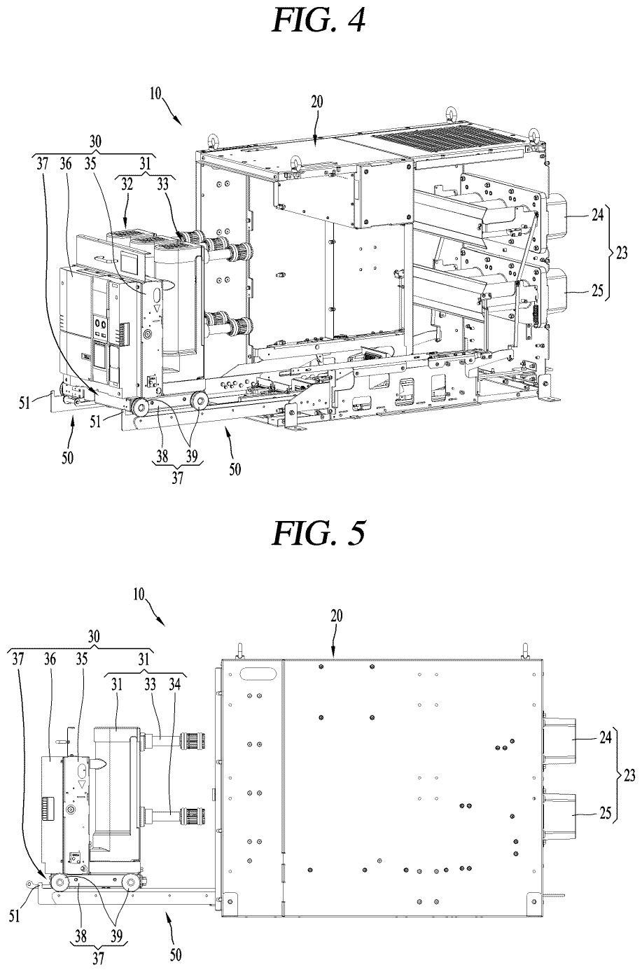

### DETAILED DESCRIPTION

Hereinafter, embodiments disclosed herein will be described in detail with reference to the accompanying drawings. Herein, even in different embodiments, the same or similar reference numerals are designated to the same or similar configurations, and the description thereof will be substituted by the earlier description. A singular expression used herein may include a plural expression unless clearly defined otherwise in the context. In describing embodiments disclosed herein, moreover, the detailed description will be omitted when specific description for publicly known technologies to which the disclosure pertains is determined to obscure the gist of the present disclosure. Also, it should be noted that the accompanying drawings are merely illustrated to easily explain the concept of the disclosure, and therefore, they should not be construed to limit the technological concept disclosed herein by the accompanying drawings.

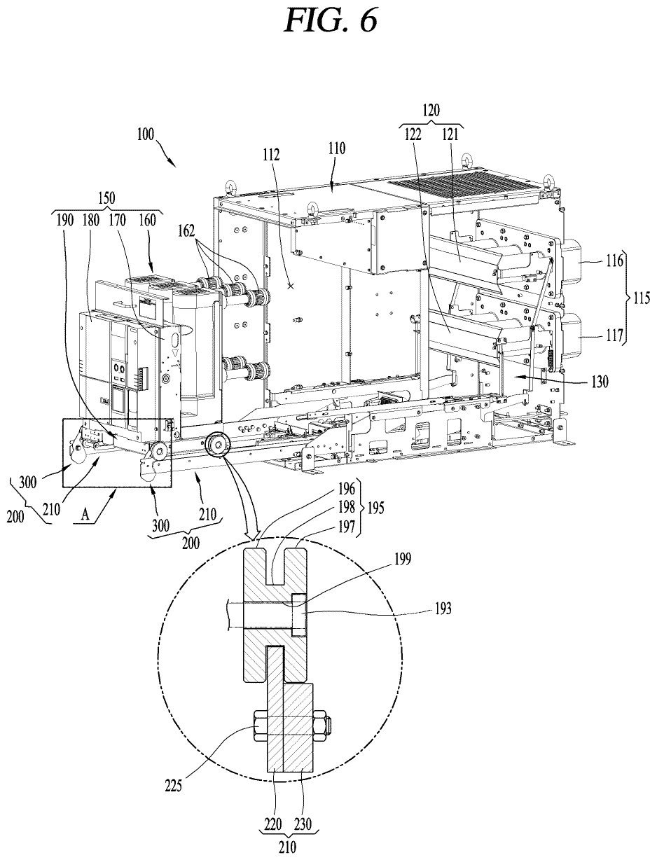

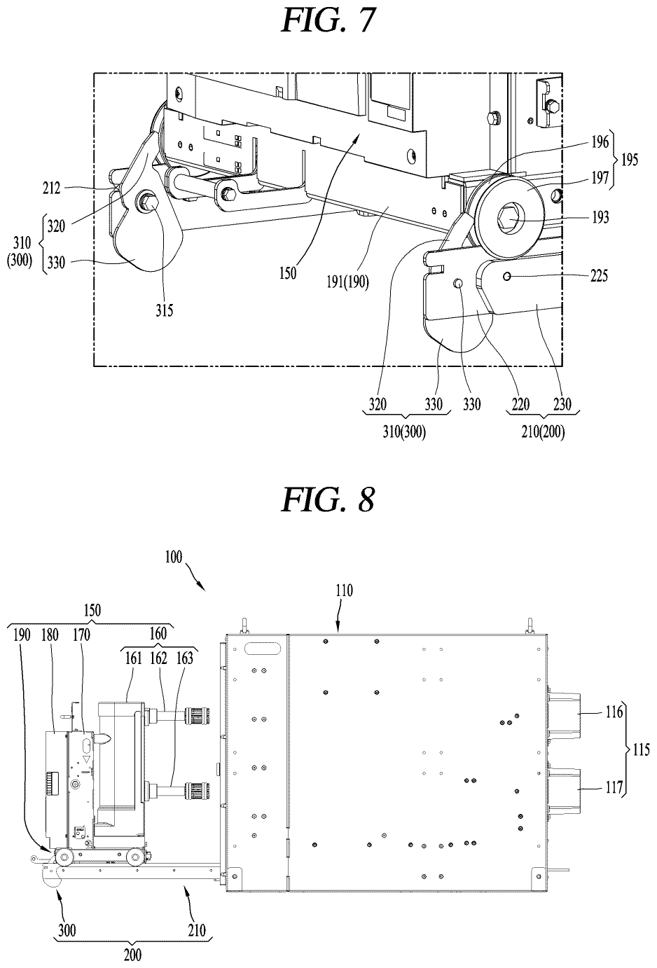

FIG. 6 is a perspective view of a distribution board including a circuit breaker guide rail according to one embodiment of the present disclosure, FIG. 7 is an enlarged view of a main part of FIG. 6, and FIG. 8 is a side view of the distribution board of FIG. 6. As shown in FIGS. 6 to 8, a distribution board 100 according to one embodiment of the present disclosure has an enclosure 110, a circuit breaker 150, and a guide rail 200.

The enclosure 110 can be implemented, for example, in an approximately rectangular parallelepiped shape.

The enclosure 110 can be arranged, for example, at a preset distance upward from the installation floor surface.

The enclosure 110 can be provided with an accommodation space with an open front surface on thereinside.

Although not shown in the drawing, a door that opens and closes an opening of the enclosure 110 can be provided at a front opening of the enclosure 110.

An external terminal 115 can be provided in an internal rear area of the enclosure 110.

The external terminal 115 can, for example, be provided with an upper terminal 116 and a lower terminal 117 spaced vertically apart.

The upper terminal 116 and lower terminal 117 are respectively configured in three pieces spaced apart horizontally to correspond to each phase (R phase, S phase, T phase) of a three-phase AC power source, for example.

Here, one of the upper terminal 116 and the lower terminal 117 can be connected to a bus, and the other can be connected to a load.

A circuit breaker compartment 112 in which the circuit breaker 150 is accommodated is formed in an internal front area of the enclosure 110.

A shutter 120 that opens and closes the external terminal 115 is provided in a front area of the external terminal 115.

The shutter 120 includes, for example, an upper shutter 121 that opens and closes a front end of the upper terminal 116 and a lower shutter 122 that opens and closes a front end of the lower terminal 117.

The enclosure 110 is provided with a link device 130 so as to allow the shutter 120 at a front end of the outer terminal to be opened when the circuit breaker 150 enters a run location.

The link device 130 can be configured, for example, such that the upper shutter 121 and the lower shutter 122 can be opened and closed simultaneously.

The circuit breaker 150 can be configured to include, for example, a main circuit part 160, a driving part 170 that provides a driving force to the main circuit part 160, an operating part 180 that inputs a signal such that the main circuit part 160 can perform a closing operation or a trip operation, and a transfer part 190 formed on a lower side of the main circuit part 160, the driving part 170, and the operating part 180 so as to transfer the main circuit part 160, the driving part 170, and the operating part 180.

The main circuit part 160 is configured to include a vacuum container, and a vacuum interrupter 161 having a fixed contactor and a movable contactor that are arranged to be in contact with and separated from each other inside the vacuum container, although not specifically shown in the drawing. The main circuit part 160 can be implemented as a vacuum circuit breaker having an upper connection part 162 and a lower connection part 163 respectively connected to the fixed contactor and the movable contactor.

In this embodiment, it is shown a case where the circuit breaker 150 is implemented as a vacuum circuit breaker, but this is only an example and is not limited thereto.

The circuit breaker 150 is formed such that, when at the run location, the upper connection part 162 and the lower connection part 163 can be conductively connected to the upper terminal 116 and the lower terminal 117 of the enclosure 110, respectively.

The transfer part 190 includes a bogie 191 on which the main circuit part 160, the driving part 170 and the operating part 180 are placed, and a plurality of wheels 195 that are rotatably provided on the bogie 191.

The plurality of wheels 195 are respectively provided on both front and rear sides of the bogie.

In this embodiment, the plurality of wheels 195 are implemented to be four in number.

Each of the plurality of wheels 195 includes an inner wheel 196 and an outer wheel 197 spaced apart along an axial direction.

Each of the plurality of wheels 195 includes a connection part 198 that connects the inner wheel 196 and the outer wheel 197.

The inner wheel 196 and the outer wheel 197 can be configured to include, for example, the same outer diameter (outer circumferential surface).

The connection part 198 has an outer diameter that is reduced compared to the outer diameters of the inner wheel 196 and the outer wheel 197.

Thereby, a concave groove is formed between the inner wheel 196 and the outer wheel 197.

Inside the connection part 198, for example, a rotation shaft 193 coupled to the bogie 191 can be accommodated and coupled so as to allow relative movement.

A rotation shaft hole 199 in which the rotation shaft 193 is accommodated to allow relative movement is formed at the connection part 198 to pass therethrough.

The guide rail 200 is inserted and coupled between the inner wheel 196 and the outer wheel 197.

Thereby, the circuit breaker 150 can be inhibited from moving laterally.

The guide rail 200 is provided at a front of the enclosure 110.

The guide rails 200 are provided on both sides of the front of the enclosure 110.

The guide rails 200 are arranged to extend forward in parallel with each other from a front end of the enclosure 110.

The guide rails 200 are respectively coupled so as to allow rear ends to be inserted into both sides of the enclosure 110 at a preset depth (length).

Each of the guide rails 200 is supported by the enclosure 110 at a preset height from the installation floor surface.

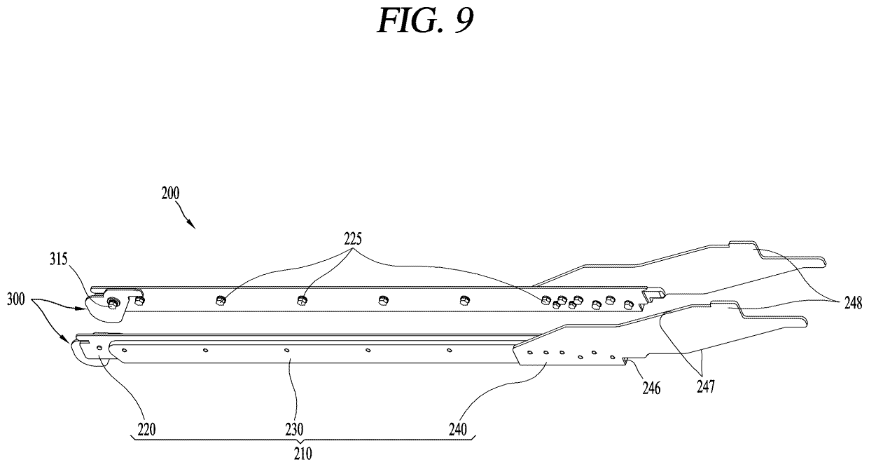

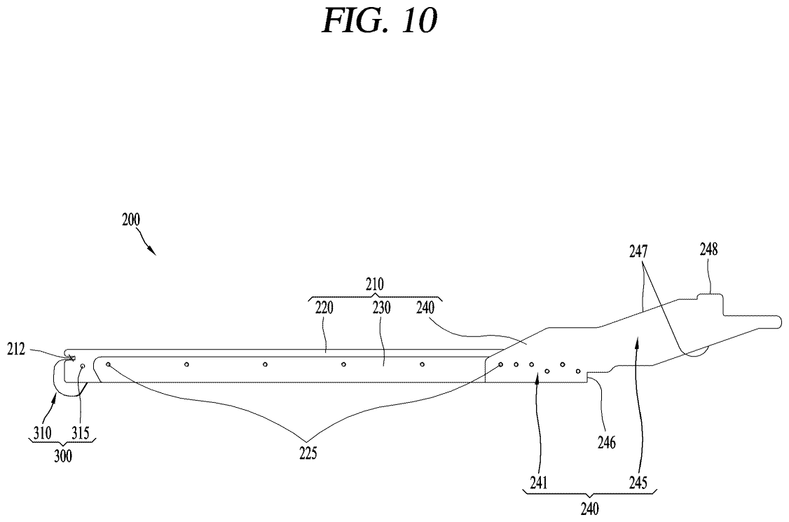

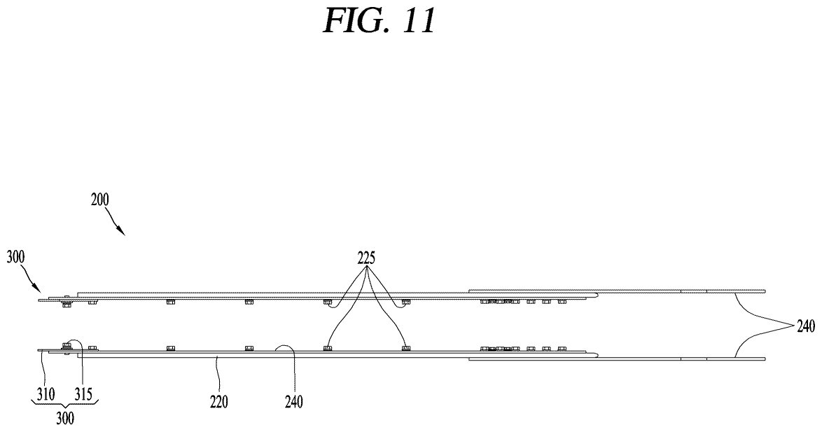

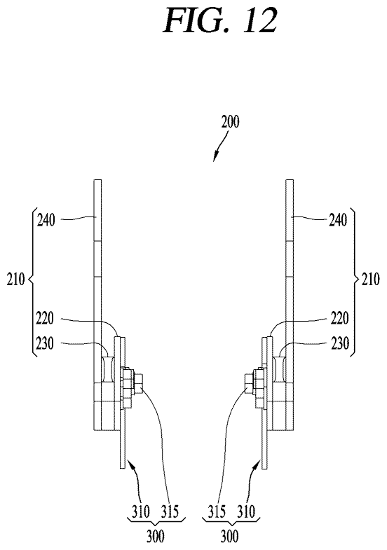

FIG. 9 is a perspective view of a circuit breaker guide rail according to one embodiment of the present disclosure in FIG. 6, FIG. 10 is a front view of the guide rail of FIG. 9, FIG. 11 is a plan view of the guide rail of FIG. 9, and FIG. 12 is a left side view of the guide rail of FIG. 9. As shown in FIGS. 9 to 12, a circuit breaker guide rail 200 according to one embodiment of the present disclosure includes a guide rail body 210 and an interlock device 300.

The guide rail body 210 is arranged in a front-rear direction at a front of the enclosure 110 such that the circuit breaker 150 moves in a front-rear direction along the guide rail body 210.

The guide rail body 210 is configured to have a length that allows the circuit breaker 150 to be extended to the front of the enclosure 110.

The guide rail body 210 is configured to have a length, excluding a length inserted into the enclosure 110, that is longer than that in a front-rear direction of the circuit breaker 150.

The guide rail body 210 is configured as a pair so as to allow, for example, the four wheels 195 of the circuit breaker 150 to be respectively coupled thereto to move.

The guide rail body 210 includes an inner plate 220 and an outer plate 230 that are coupled to each other along a thickness direction, for example.

The inner plate 220 and the outer plate 230 are integrally fixedly coupled by a plurality of fastening members 225 passing through a plate surface.

The guide rail body 210 includes, for example, a coupling plate 240 coupled to the enclosure 110.

The coupling plate 240 forms, for example, a rear end of the guide rail body 210.

The coupling plate 240 can be integrally fixedly coupled to the inner plate 220 and the outer plate 230 by, for example, a plurality of fastening members 225 passing through the plate surface.

Here, the coupling plate 240 is inserted into the enclosure 110 and must support not only a load of the guide rail body 210 itself but also a load of the circuit breaker 150 placed on the upper surface, and thus a relatively large coupling force is required.

Accordingly, a relatively large number of fastening members 225 can be coupled to the coupling plate 240.

One ends (front area) of the coupling plate 240 are respectively coupled to rear ends of the inner plate 220 and the outer plate 230, and the other ends (rear area) thereof are respectively inserted and coupled to the enclosure 110.

The coupling plate 240 includes, for example, a coupling section 241 coupled to the inner plate 220 and the outer plate 230 and an insertion section 245 inserted and coupled into the enclosure 110.

A cut-out part 246 is formed below the coupling plate 240 to limit a depth of insertion into the enclosure 110.

The insertion section 245 is configured, for example, to include an inclined part 247 formed to extend rearward and upward in an inclined manner in a rear area of the coupling section 241.

An upwardly protruding coupling protrusion 248 is provided at an upper end of the insertion section 245 of the coupling plate 240.

The coupling protrusion 248, although not specifically shown in the drawing, can be inserted and coupled to a coupling protrusion accommodation hole formed in the enclosure 110 to correspond to the coupling protrusion 248.

The guide rail 200 can be inhibited from moving relative to the upper direction, left-right direction, and front-rear direction of the enclosure 110 by the combination structure of the cut-out part 246 and the combination structure of the coupling protrusion 248.

Here, the inner plate 220 and the outer plate 230 are implemented in a long rectangular plate shape.

A width of the inner plate 220 can be formed to be larger compared to that of the outer plate 230 by a preset width.

The inner plate 220 and the outer plate 230 are coupled such that their bases are arranged on the same plane.

Accordingly, an upper surface of the inner plate 220 can protrude further upward compared to an upper surface of the outer plate 230.

According to this configuration, the upper surface of the inner plate 220 can be inserted between the inner wheel 196 and the outer wheel 197 of the plurality of wheels 195 of the circuit breaker 150.

Specifically, a difference between a width (height) of the inner plate 220 and a width (height) of the outer plate 230 can be configured to be the same as that between a radius of the outer wheel 197 of the plurality of wheels 195 of the circuit breaker 150 and a radius of the connection part 198.

Thereby, when an upper end of the inner plate 220 is inserted and coupled to the plurality of wheels 195 of the circuit breaker 150, the upper end of the inner plate 220 can be in rolling contact with the connection parts 198 of the plurality of wheels 195, and the upper end of the outer plate 230 can be in rolling contact with the outer wheels 197 of the plurality of wheels 195.

Thereby, a load of the circuit breaker 150 can be distributed and supported by the connection part 198 and the inner plate 220, and the outer wheel 197 and the outer plate 230, respectively.

The inner wheels 196 of the plurality of wheels 195 are respectively arranged on an inner side of the inner plate 220, and the outer wheels 197 of the plurality of wheels 195 are respectively arranged on an outer side of the inner plate 220.

Thereby, the plurality of wheels 195 of the circuit breaker 150 can be moved along an upper surface of the inner plate 220, and lateral movement can be inhibited.

The inner plate 220 is configured to protrude further forward compared to the outer plate 230.

The inner plate 220 is configured to include, for example, a front end that protrudes forward compared to a front end of the outer plate 230.

A front end of the inner plate 220 is provided with the interlock device 300.

The interlock device 300 is configured to include an interlock body 310 arranged at either a permitted location that permits movement of the circuit breaker 150 or an inhibition location that inhibits the movement of the circuit breaker 150.

The interlock body 310 can be configured to be rotatable, for example, with respect to the guide rail 200.

The guide rail 200 (guide rail body 210) is provided with a rotation shaft 315 that rotatably supports the interlock body 310.

The interlock body 310 can be implemented, for example, in a plate shape.

The interlock body 310 is configured to include an inhibition part 320 that protrudes upward from the guide rail 200 (guide rail body 210) when at the inhibition location.

The guide rail 200 (guide rail body 210) is provided with a support part 317 that supports the rotation of the interlock body 310 to be inhibited when the interlock body 310 is at the inhibition location.

The support part 317 can be formed to protrude from a surface of the guide rail body 210 so as to be in contact with one side of the interlock body 310.

Here, the support part 317 can be formed at a location that can inhibit the rotation of the interlock body 310 away from the permitted location (counterclockwise in the drawing) when the interlock body 310 is at the inhibition location.

The support part 317 can be arranged at a point spaced rearward from the location of the rotation shaft 315 of the guide rail 200.

In this embodiment, the support part 317 is implemented as a bolt protruding from an inner surface of the guide rail body 210, but this is only an example and is not limited thereto.

The interlock body 310 is configured to include, for example, an expansion part 330 having a larger size (mass) compared to the inhibition part 320.

The inhibition part 320 can be configured to extend to one side (upper side in the drawing) with the rotation shaft 315 as the center, and the expansion part 330 can be configured to extend to the other side (lower side in the drawing).

In this embodiment, the inhibition part 320 and the expansion part 330 can have, for example, the same thickness, and the expansion part 330 can be configured to have an expanded size (width and/or height) compared to the inhibition part 320.

That is, the expansion part 330 can be configured to have an increased mass compared to the inhibition part 320.

According to this configuration, the interlock body 310 can be rotated to an inhibition location around the rotation shaft 315 by its own weight (gravity).

The inhibition part 320 protrudes upward from the guide rail 200, and the expansion part 330 is arranged downward from the inhibition part 320.

The inhibition part 320 can be configured, for example, to include a linear section 322 arranged parallel to an upper surface of the guide rail body 210 when the interlock body 310 is at the permitted location.

The linear section 322 can be arranged, for example, on a lower side of the inner wheel 196 among the wheels 195 of the circuit breaker 150 when the wheels 195 of the circuit breaker 150 move along the guide rail 200.

Thereby, unnecessary interference between the wheel 195 of the circuit breaker 150 and the interlock body 310 can be inhibited.

According to this configuration, when the circuit breaker 150 that has moved a front of the guide rail 200 by the lifter 400 to be described later is moved from the lifter 400 to an upper surface of the guide rail 200, the circuit breaker 150 can be smoothly moved to the upper surface of the guide rail 200 without unnecessary interference between the wheel 195 of the circuit breaker 150 and the interlock body 310.

The inhibition part 320 can be arranged to form an acute angle with respect to the upper surface of the inner plate 220.

The linear section 322 can be arranged to form an acute angle with respect to the upper surface of the inner plate 220 when the interlock body 310 is at the inhibition location.

The inhibition part 320 can be configured to be in contact with a point greater than half a height of the wheel 195 of the circuit breaker 150 when it comes into contact with the wheel 195 at the inhibition location.

Thereby, when the circuit breaker 150 is placed on the upper surface of the guide rail 200 (guide rail body 210), an external force toward the front of the guide rail 200 can be unexpectedly applied to the circuit breaker 150.

In this case, the interlock body 310 of this embodiment is configured such that the inhibition part 320 can come into contact with the wheel 195 of the circuit breaker 150 at a point greater than half a height of the wheel 195, thereby inhibiting a phenomenon of the wheel 195 of the circuit breaker 150 going over the inhibition part 320 of the interlock body 310 and being detached from the guide rail 200.

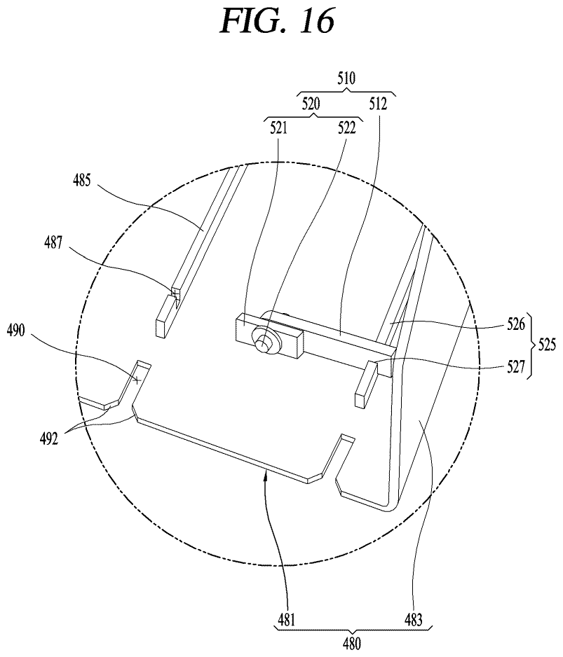

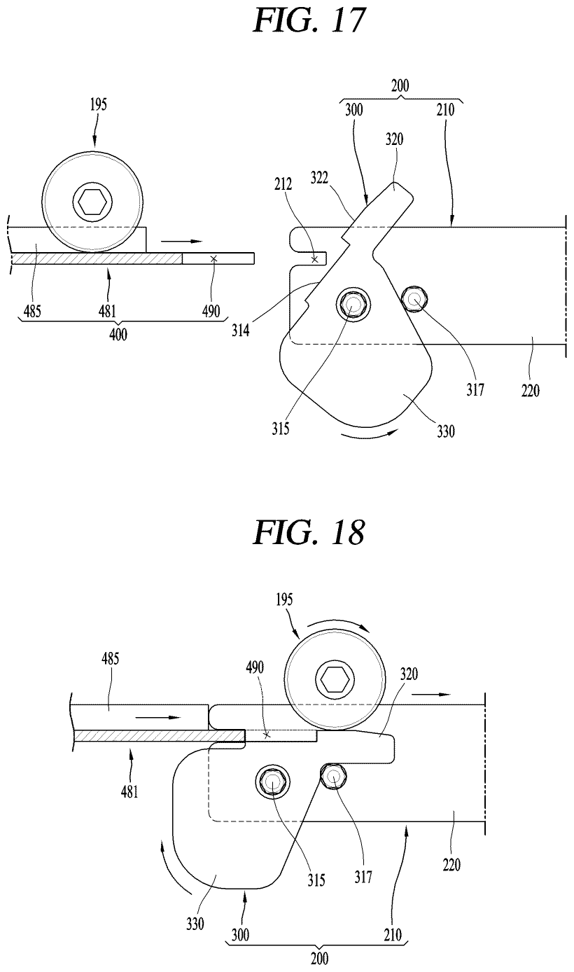

The interlock body 310 is provided with a lifter contact part 314 that comes into contact with the lifter 400 when the lifter 400 and the guide rail 200 are coupled to each other (see FIG. 17).

The lifter contact part 314 can be formed, for example, by cutting out one side of the linear section 322 to correspond to a shape of the lifter 400, when the interlock body 310 is at the permitted location.

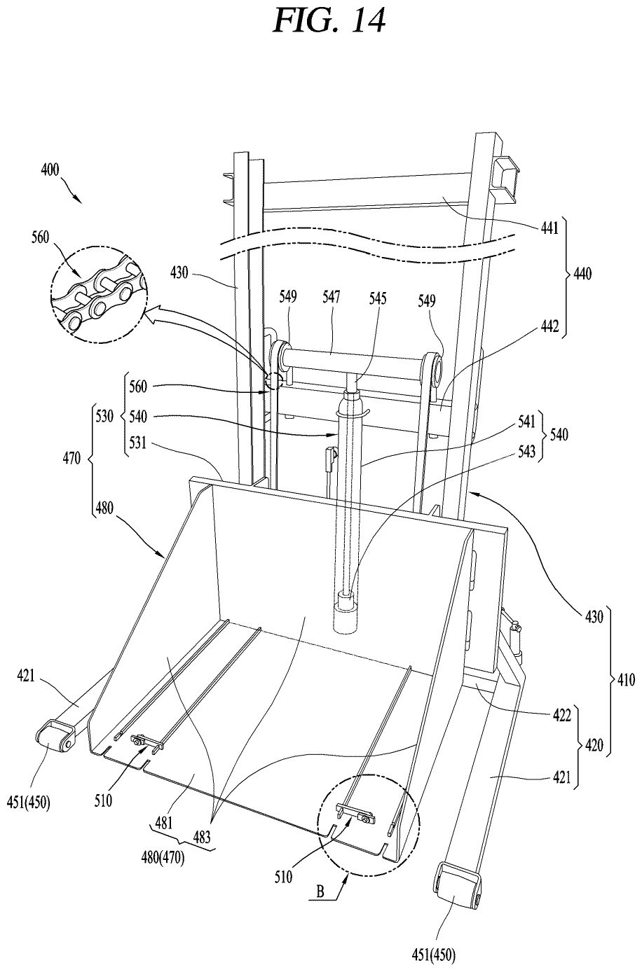

The lifter contact part 314 can be formed to be cut out in an inverted “L” shape to correspond to a fore end shape (see FIG. 14) of the base 481 of the lifter 400 having a rectangular cross-section, for example.

Meanwhile, the guide rail 200 is provided with a lifter coupling part 212 to which, for example, the lifter 400 is coupled.

The lifter coupling part 212 can be formed, for example, to be cut out to a preset length from a front end of the guide rail 200 toward a rear end thereof.

The lifter coupling part 212 can be formed, for example, to be cut out from a front end of the inner plate 220 of the guide rail body 210 toward a rear end thereof.

Here, the lifter coupling part 212 can be formed to have an expanded thickness (height) compared to a thickness of the base 481 so as to allow a fore end of the base 481 of the lifter 400 to be described later to be inserted thereinto.

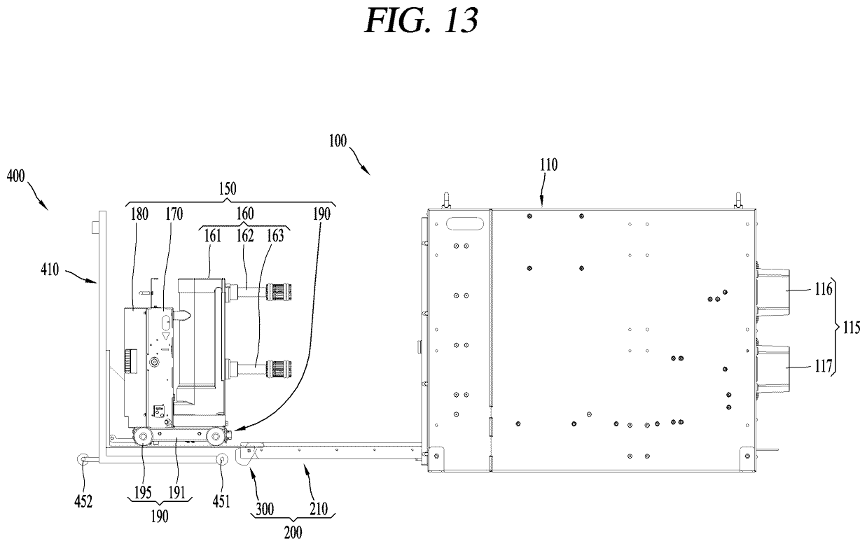

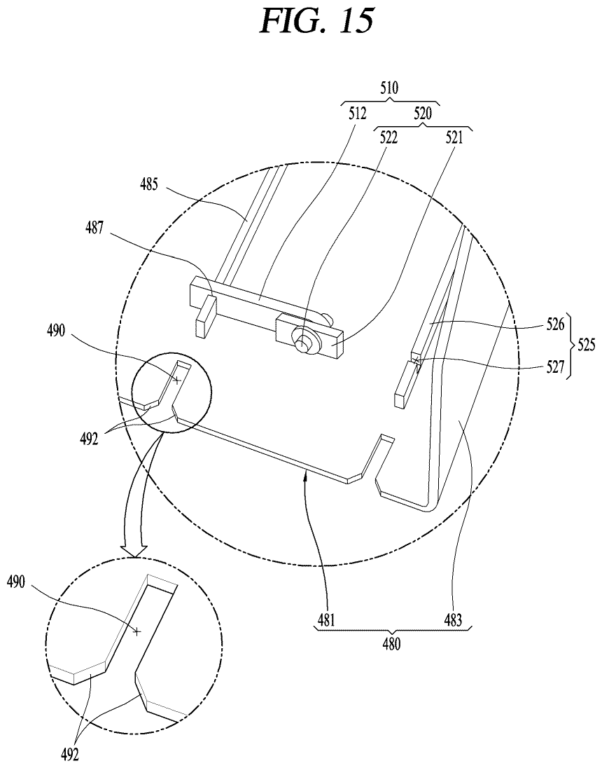

FIG. 13 is a drawing showing a state in which the circuit breaker of FIG. 6 is placed on a lifter prior to being moved to the guide rail, FIG. 14 is a perspective view of the lifter of FIG. 13, FIG. 15 is an enlarged perspective view of a main part of the lifter of FIG. 14, and FIG. 16 is a drawing showing a state in which a cross pin of FIG. 15 is spaced apart from a wheel guide part.

As shown in FIG. 13, the circuit breaker 150 can be moved by the lifter 400 that can be raised and lowered to a height of the guide rail 200 to be put into the enclosure 110.

The lifter 400 is configured to include a lifter body 410 and an lifting part 470, as shown in FIG. 14.

The lifter body 410 is configured to include a plurality of rollers 450 to be driven.

The lifter body 410 includes, for example, a horizontal frame 420 and a vertical frame 430.

The horizontal frame 420 includes, for example, a first horizontal frame 421 spaced apart along a width direction and a second horizontal frame 422 connecting a rear end of the first horizontal frame 421.

The vertical frame 430 can be formed to extend, for example, upward from the horizontal frame 420.

The vertical frame 430 can be implemented as a pair spaced apart along a width direction, for example.

The vertical frame 430 can, for example, have a bottom fixedly coupled to the second horizontal frame 422.

The vertical frame 430 is provided with a connection frame 440 connecting the vertical frames 430 that are spaced apart from each other.

The connection frame 440 includes, for example, an upper connection frame 441 provided on a top of the vertical frame 430 and a central connection frame 442 provided at the center of the vertical frame 430.

The horizontal frame 420 is provided with a plurality of wheels or rollers 450 (hereinafter, referred to as “rollers 450”) to allow driving.

The roller 450 includes a front roller 451 provided at a front end of the first horizontal frame 421.

The roller 450 includes a rear roller 452 provided on the second horizontal frame 422 or the vertical frame 430.

The front roller 451 and the rear roller 452 can be configured to be rotatable around a rotation shaft arranged along a width direction, for example.

Meanwhile, the lifting part 470 is configured to raise and lower the circuit breaker 150.

The lifting part 470 is provided so as to be raised and lowered on the lifter body 410.

The lifting part 470 includes, for example, a car 480 on which the circuit breaker 150 is placed, and a driving part 530 that raises and lowers the car 480.

The car 480 includes, for example, a base 481 on which the circuit breaker 150 is placed, and a plurality of side walls 483 respectively vertically coupled to both sides and rear of the base 481.

The base 481 can be implemented, for example, in a rectangular plate shape.

Here, the side walls 483 provided on both sides of the base 481 are formed to be inclined upward so as to allow the height to increase rearward.

A maximum height of the side walls 483 provided on both sides of the base 481 and a height of the side walls 483 provided at the rear can be configured to be the same.

Here, the horizontal frame 420 of the lifter 400 is configured to be arranged on an outside (both sides and rear) of the car.

Thereby, the car 480 can be lowered so as to be in contact with the floor surface.

According to this configuration, the circuit breaker 150 placed on the floor surface can be easily moved to an upper surface of the base 481 by pushing the circuit breaker 150 while the car 480 is lowered so as to allow the base 481 of the car 480 to be in contact with the floor surface.

The driving part 530 includes, for example, a slider 531 that rises and falls along the vertical frame 430, an actuator 540 that can be stretched up and down, and a connection member 560 that has one end connected to the slider 531 and the other end connected to the actuator 540.

The slider 531 is integrally fixedly coupled to the car 480.

The slider 531 is fixedly coupled to the side wall 483 at a rear of the car 480.

Thereby, when the slider 531 is raised or lowered, the car 480 can be raised or lowered together.

The vertical frame 430 can be formed to have, for example, a “U” cross-sectional shape in which one side (inner side in the drawing) is opened.

A guide roller (not shown) that can be raised and lowered by being in rolling contact with an inside of the vertical frame 430 can be provided in a rear area of the slider 531. The guide rollers can be respectively configured in plurality, for example, spaced apart vertically inside each of the vertical frames 430. Thereby, the slider 531 can be raised and lowered smoothly while a clearance in front-rear and left-right directions is inhibited.

The actuator 540 is configured, for example, to include a cylinder 541 and a piston 543 that reciprocates inside the cylinder 541.

A bottom of the cylinder 541 of the actuator 540 can, for example, be connected to the second horizontal frame 422 and a top thereof can be connected to the central connection frame 442 provided at the center of the vertical frame 430.

The piston 543 is provided with a piston rod 545.

One end of the piston rod 545 is connected to the piston 543 and the other end thereof is exposed to an outside of the cylinder 541.

A guide rod 547 extending horizontally is provided at an exposed end of the piston rod 545.

The connection member 560 can be implemented, for example, as a chain.

In this embodiment, it is illustrated a case where the connection member 560 is implemented as a chain, but this is only an example and is not limited thereto. The connection member 560 can be implemented as a cable.

One end (lower end in the drawing) of the connection member 560 is connected to a lower end of the slider 531, and the other end (upper end in the drawing) thereof can be fixed to the central connection frame 442 by way of upper ends (upper surfaces) of both ends of the guide rod 547.

Thereby, when the guide rod 547 rises, the connection member 560 can be pressed upward, so as to allow an end of the connection member 560 connected to the slider 531 to move upward, thereby allowing the slider 531 and the car 480 to rise together.

At both end areas of the guide rod 547, guide ribs 549 can be respectively provided to guide the chain to be in contact with a circumferential surface of the guide rod 547 so as to move relative thereto.

The guide ribs 549 are formed to protrude radially from a surface of the guide rod 547 on both sides of the connection member 560.

Thereby, the connection member 560 can be inhibited from being detached from the guide rod 547.

By this configuration, when the piston rod 545 rises, the guide rod 547 rises, and the guide rod 547 moves upward away from the central connection frame 440.

Accordingly, each connection member 560 whose upper end is connected to the central connection frame 440 is pulled upward from its lower end, thereby allowing the slider 531 to move upward.

Meanwhile, the base 481 of the car 480 is provided with a wheel guide part 485 coupled to the wheel 195 of the circuit breaker 150 to guide movement of the wheel 195 of the circuit breaker 150.

The wheel guide part 485 can be configured to be inserted and coupled between the inner wheel 196 and the outer wheel 197 of the circuit breaker 150.

Thereby, lateral movement of the circuit breaker 150 can be inhibited.

The wheel guide part 485 is formed to extend along a front-rear direction on the upper surface of the base 481.

The wheel guide parts 485 are formed as a pair spaced apart along a width direction of the base 481 to correspond to, for example, the wheels 195 of the circuit breaker 150.

The base 481 is provided with a guide rail body coupling part 490 coupled to the guide rail body 210.

The guide rail body coupling part 490 can be configured to be coupled to, for example, the lifter coupling part 212 of the guide rail 200.

The guide rail body coupling part 490 can be formed, for example, on an extension line of the wheel guide part 485.

Thereby, when the lifter 400 and the guide rail 200 are coupled to each other, the wheel guide part 485 and the guide rail 200 can be aligned to a preset location.

Specifically, the wheel guide part 485 and the guide rail body coupling part 490 can be formed to be arranged on the same line as the inner plate 220 of the guide rail body 210.

According to this configuration, when the lifter 400 and the guide rail 200 are coupled to each other, the wheel 195 of the circuit breaker 150 placed on the wheel guide part 485 is aligned with the inner plate 220 of the guide rail body 210, thereby allowing the circuit breaker 150 of the lifter 400 to smoothly move to an upper surface of the guide rail 200 (inner plate 220 of the guide rail body 210).

A guide part 492 is formed at the guide rail body coupling part 490 such that when coupled to the guide rail 200, the guide rail 200 (inner plate 220) can be guided into the guide rail body coupling part 490.

The guide part 492 can be formed, for example, to increase an inner width toward the front.

The guide parts 492 can respectively be formed to be inclined outward toward the front.

The wheel guide part 485 is provided with a detachment inhibition part 510 that is arranged to cross with the wheel guide part 485 to inhibit the circuit breaker 150 from being detached unexpectedly.

The detachment inhibition part 510 includes, for example, a cross pin 512 arranged to cross with the wheel guide part 485 and a cross pin support part 520 that supports the cross pin 512.

The detachment inhibition part 510 can be provided, for example, at a front end of the wheel guide part 485.

Thereby, the circuit breaker 150 can be inhibited from being detached from the front end of the wheel guide part 485.

The wheel guide part 485 is provided with a cross pin accommodation part 487 to accommodate the cross pin 512.

The cross pin accommodation part 487 can be formed, for example, by being cut from an upper end of the wheel guide part 485 to a preset depth.

A depth of the cross pin accommodation part 487 can be formed to be smaller compared to a height (thickness) of the cross pin 512, for example.

Thereby, when the cross pin 512 is accommodated in the cross pin accommodation part 487, an upper end of the cross pin 512 can protrude more than the wheel guide part 485.

The cross pin support part 520 can be configured to rotatably support an end of the cross pin 512 on an outside of the wheel guide part 485 along a width direction of the base 481, for example.

The cross pin support part 520 is configured to include, for example, a support piece 521 protruding from the upper surface of the base 481 and a rotation pin 522 coupled to the support piece 521 to rotatably support the cross pin 512.

The detachment inhibition part 510 can be provided with a cross pin fixing part 525 that fixes the cross pin 512 so as to allow the cross pin 512 to be maintained in a state of being spaced apart from the wheel guide part 485, for example, as shown in FIG. 14.

The cross pin fixing part 525 can be configured to include, for example, a rib 526 formed parallel to the wheel guide part 485 and a cut-out part 527 formed so as to accommodate an end of the cross pin 512.

The ribs 526 can be respectively formed, for example, on an outer side of the wheel guide part 485 along a width direction of the base 481.

The ribs 526 can be formed close to both side walls 483 of the car.

Here, the rib 526 can be formed to have the same size as the wheel guide part 485.

According to this configuration, when a size of the circuit breaker 150 increases in a width direction, the rib 526 can function as the wheel guide part 485 that guides the wheel 195 of the circuit breaker 150 whose size has increased in the width direction, and the wheel guide part 485 provided on an inside of the rib 526 can function as the cross pin fixing part 525 that fixes the cross pin 512.

According to this configuration, the lifter 400 can be mounted with two circuit breakers 150 having different sizes of width.

With this configuration, when the circuit breaker 150 is to be brought into the enclosure 110, the circuit breaker guide rail 200 is arranged at a front of the enclosure 110.

The circuit breaker guide rail 200 allows rear ends (coupling plate 240) of the guide rail 200 to be respectively inserted and coupled to both sides of a front opening of the enclosure 110 while a front end provided with the interlock device 300 is located at a front thereof.

Next, as shown in FIG. 13, the circuit breaker 150 to be put into the enclosure 110 is moved to a front of the guide rail 200 by the lifter 400.

Here, when the circuit breaker 150 is mounted on the lifter 400, a front part (operating part 180) of the circuit breaker 150 faces a rear of the base 481 of the lifter 400, and the upper connection part 162 and the lower connection part 163 of the circuit breaker 150 face a front of the base 481.

A plurality of wheels 195 of the circuit breaker 150 are each coupled to the wheel guide part 485 of the base 481 of the lifter 400, and in this case, as shown in FIG. 15, the cross pin 512 at the front end of the wheel guide part 485 is inserted and coupled to the cross pin accommodation part 487 so as to be arranged to cross with the wheel guide part 485. Thereby, the circuit breaker 150 can be inhibited from being detached from the wheel guide part 485.

Next, the actuator 540 is operated to raise the car 480 away from the floor surface, and then the lifter 400 is pushed to move the lifter 400 toward the enclosure 110.

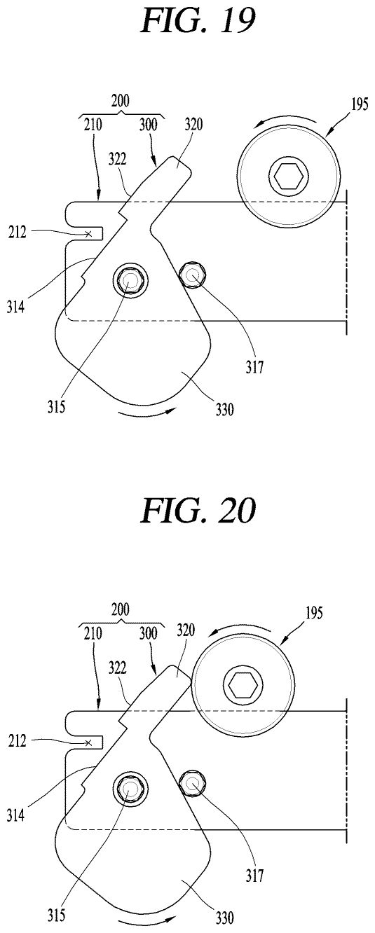

FIG. 17 is a drawing showing an inhibition location between a wheel of the circuit breaker and an interlock device prior to coupling of the lifter of FIG. 13, FIG. 18 is a drawing showing a permitted location between the wheel of the circuit breaker and the interlock device during the coupling of the lifter in FIG. 17, FIG. 19 is a drawing showing an inhibition location between the wheel of the circuit breaker and the interlock device in FIG. 18, and FIG. 20 is a drawing for explaining an operation between the wheel of the circuit breaker and the interlock device in FIG. 19.

As shown in FIG. 17, the interlock body 310 is arranged at the inhibition location by its own weight at a front end of the guide rail body 210.

The guide rail body coupling part 490 is arranged at a front of the lifter coupling part 212 of the guide rail body 210.

When the lifter 400 is moved by pressing toward the guide rail 200, a fore end of the base 481 comes into contact with the interlock body 310.

When the lifter 400 continues to move toward the guide rail 200, as shown in FIG. 18, the interlock body 310 is pressed by the base 481 to rotate around the rotation shaft 315 to the permitted location.

In this case, a front end of the inner plate 220 is inserted into the guide rail body coupling part 490 of the base 481, and a rear area of the guide rail body coupling part 490 is inserted into the lifter coupling part 212.

When a coupling between the lifter 400 and the guide rail 200 is completed, a front end of the wheel guide part 485 comes into contact with a front end of the inner plate 220.

In this case, an upper end of the wheel guide part 485 and an upper end of the inner plate 220 have almost the same height.

The interlock body 310 is arranged on a lower side of the fore end of the base 481.

In this case, when the circuit breaker 150 placed on an upper surface of the base 481 is pressed toward the enclosure 110, the plurality of wheels 195 of the circuit breaker 150 move along the wheel guide part 485 to an upper surface of the guide rail 200.

When the circuit breaker 150 is continuously pressed, all (four) of the plurality of wheels 195 of the circuit breaker 150 are moved to an upper surface of the inner plate 220 of the guide rail 200.

In this case, when the lifter 400 is moved forward to separate from the guide rail 200, the interlock body 310 rotates to the inhibition location by its own weight, as shown in FIG. 19.

Here, when the circuit breaker 150 is unexpectedly moved a front of the guide rail 200 due to an external force, as shown in FIG. 20, the plurality of wheels 195 of the circuit breaker 150 come into contact with the inhibition part 320 of the interlock body 310, thereby inhibiting the circuit breaker 150 from moving to the front end of the guide rail 200.

According to this configuration, the circuit breaker 150 can be prevented from being detached from a front end of the circuit breaker guide rail 200 to fall (overturn).

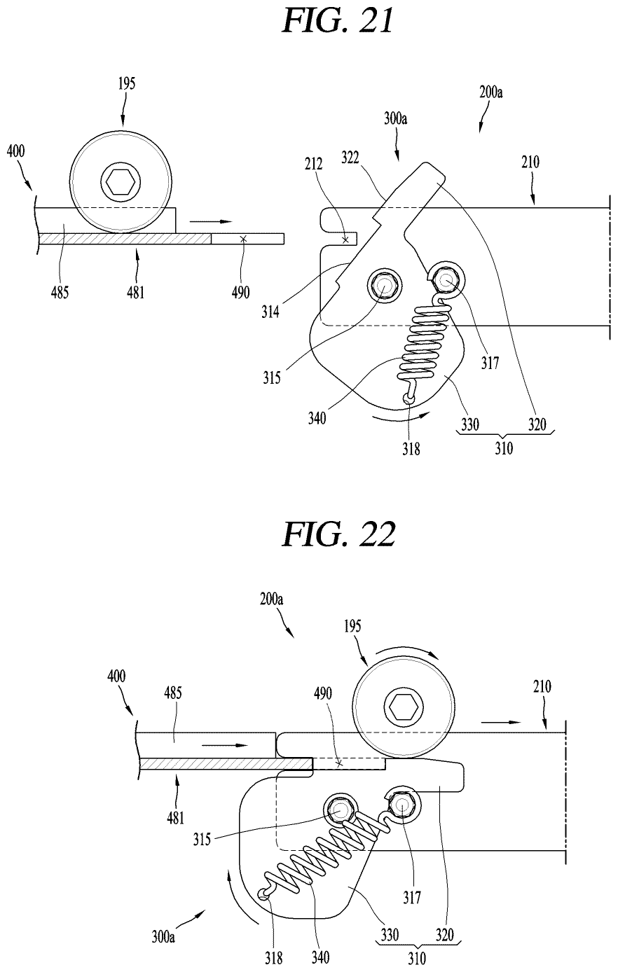

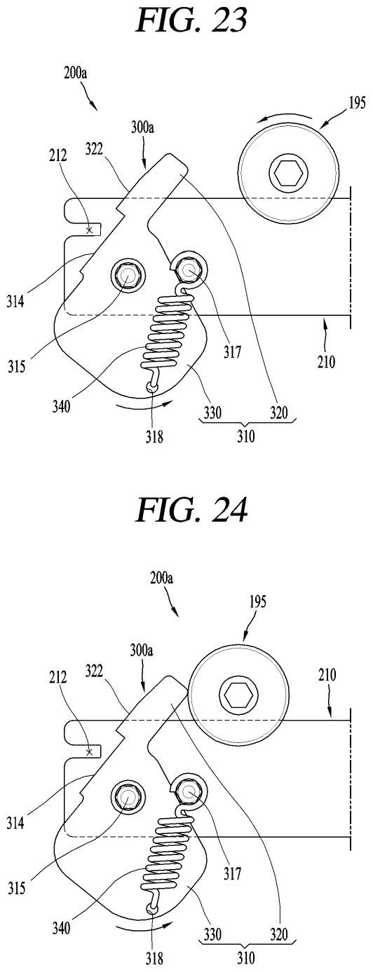

FIG. 21 is a drawing showing an interlock device area of a circuit breaker guide rail according to another embodiment of the present disclosure, FIG. 22 is a drawing showing a permitted location between the wheel of the circuit breaker and the interlock device in FIG. 21, FIG. 23 is a drawing showing an inhibition location between the wheel of the circuit breaker and the interlock device in FIG. 22, and FIG. 24 is a drawing for explaining an operation between the wheel of the circuit breaker and the interlock device in FIG. 23. A circuit breaker guide rail 200a of this embodiment is configured to include a guide rail body 210 and an interlock device 300a.

The guide rail body 210 includes, as described above, an inner plate 220 and an outer plate 230 that are coupled to each other along a thickness direction, for example.

The guide rail body 210 includes a coupling plate 240 coupled to the enclosure 110.

A front end of the guide rail body 210 is provided with a lifter coupling part 212 to which the foregoing lifter 400 is coupled.

The lifter coupling part 212 can be formed, for example, to be cut from the front end of the guide rail body 210 toward a rear end.

The lifter 400, as described above, is configured to include a lifter body 410 provided with a plurality of rollers 450 to be driven, and a lifting part 470 provided to be raised or lowered on the lifter body 410.

The lifting part 470 includes a car 480 on which the circuit breaker 150 is placed, and a driving part 530 that drives the car 480 to be raised or lowered.

The car 480 includes a plate-shaped base 481 and a plurality of side walls 483 arranged on both side walls and rear end of the base 481.

The wheel guide part 485 is provided on an upper surface of the base 481 to guide a plurality of wheels 195 of the circuit breaker 150.

A guide rail body coupling part 490 is formed at a front of the wheel guide part 485 so as to allow a front end of the guide rail body 210 to be inserted.

Meanwhile, the interlock device 300a is configured to include an interlock body 310 arranged at either a permitted location that permits movement of the circuit breaker 150 or an inhibition location that inhibits the movement of the circuit breaker 150.

The interlock body 310 includes an inhibition part 320 that protrudes upward from the guide rail body 210, for example, when at the inhibition location to inhibit movement of the circuit breaker 150.

Here, the inhibition part 320 can be arranged to form an acute angle with respect to the upper surface of the inner plate 220 when at the inhibition location.

The inhibition part 320 can be, for example, configured to be in contact with a point greater than half a height of the wheel 195 of the circuit breaker 150 when it comes into contact with the wheel 195 at the inhibition location.

The guide rail body 210 is provided with a rotation shaft 315 that rotatably supports the interlock body 310.

The interlock body 310 can include, for example, an expansion part 330 that is expanded to a larger size compared to the inhibition part 320.

The expansion part 330 can be configured to be arranged, for example, on a lower side of the inhibition part 320 when the interlock body 310 is in the inhibition location.

According to this configuration, the interlock body 310 can rotate the expansion part 330 toward a lower side of the rotation shaft 315 around the rotation shaft 315 due to a mass difference between the inhibition part 320 and the expansion part 330.

The guide rail body 210 is provided with the support part 317 in contact with the interlock body 310 to support the interlock body 310 when the interlock body 310 is at the inhibition location.

The support part 317 is formed to protrude from a surface (inner surface) of the guide rail body 210.

The support part 317 is formed at a location that can inhibit the inhibition part 320 from rotating in a direction (counterclockwise in the drawing) away from the permitted location when the interlock body 310 is at the inhibition location.

In this embodiment, the support part 317 is formed at a point spaced apart from the rotation shaft 315 of the guide rail body 210 to a rear area.

A linear section 322 arranged parallel to an upper surface of the guide rail 200 when the interlock body 310 is at the permitted location is provided on one side of the interlock body 310 (inhibition part 320).

The linear section 322 can be arranged to form an acute angle with respect to the upper surface of the inner plate 220 when the interlock body 310 is at the inhibition location.

In this embodiment, the interlock device 300a is configured to include an elastic pressing part 340 that elastically presses the interlock body 310 to rotate to the inhibition location.

The elastic pressing part 340 can be implemented, for example, as a coil spring.

In this embodiment, the elastic pressing part 340 can be implemented as a tensile coil spring.

One end of the elastic pressing part 340 can be connected to, for example, the support part 317 and the other end thereof can be connected to a lower end of the interlock body 310.

A coupling hole 318 can be formed at the expansion part 330 of the interlock body 310 to pass therethrough so as to allow one end (lower end) of the elastic pressing part 340 to be coupled.

The other end (upper end) of the elastic pressing part 340 can be configured to be coupled to, for example, the support part 317.

Thereby, the interlock body 310 can be rotated counterclockwise around the rotation shaft 315 and arranged at the inhibition location since a lower area (expansion part 330) of the interlock body 310 is pulled toward the support part 317 by an elastic force of the elastic pressing part 340.

In addition, since the interlock body 310 is supported by the support part 317, movement of the circuit breaker 150 can be inhibited even when the circuit breaker 150 is unexpectedly pressed toward a front end of the guide rail 200a.

In this embodiment, it is illustrated a case where the elastic pressing part 340 is implemented as a tensile coil spring, but this is only an example and is not limited thereto. The elastic pressing part 340 can be implemented, for another example, as a compression coil spring or a torsion coil spring.

By this configuration, when the circuit breaker 150 of the lifter 400 is to be put into the enclosure 110, the lifter 400 is arranged at a front of the guide rail body 210 as shown in FIG. 21.

Next, when the guide rail body coupling part 490 of the lifter 400 is inserted and coupled into the lifter coupling part 212, as shown in FIG. 22, the interlock body 310 is pressed by the base 481 of the lifter 400 to rotate to the permitted location.

In addition, the wheel guide part 485 of the lifter 400 comes into contact with a fore end of the guide rail body 210 (inner plate 220) to have the same height.

In this case, when the circuit breaker 150 placed on an upper surface of the lifter 400 is pressed toward the enclosure 110, the wheel 195 of the circuit breaker 150 moves from the wheel guide part 485 to an upper surface of the guide rail body 210.

When the plurality of wheels 195 of the circuit breaker 150 are all moved to the upper surface of the guide rail body 210, as shown in FIG. 23, the interlock body 310 rotates to the inhibition location around the rotation shaft 315 by an elastic force of the elastic pressing part 340.

Meanwhile, when an external force is unexpectedly applied to the circuit breaker 150 that has moved to the upper surface of the guide rail 200 to move the circuit breaker 150 toward the front end of the guide rail 200a, as shown in FIG. 24, the interlock body 310 can allow the inhibition part 320 of the interlock body 310 to come into contact with the wheel 195 of the circuit breaker 150 at the inhibition location, thereby preventing the circuit breaker 150 from moving to a front of the guide rail body 210. Thereby, the circuit breaker 150 can be inhibited from being detached from the front end of the guide rail 200a to plunge or overturn.

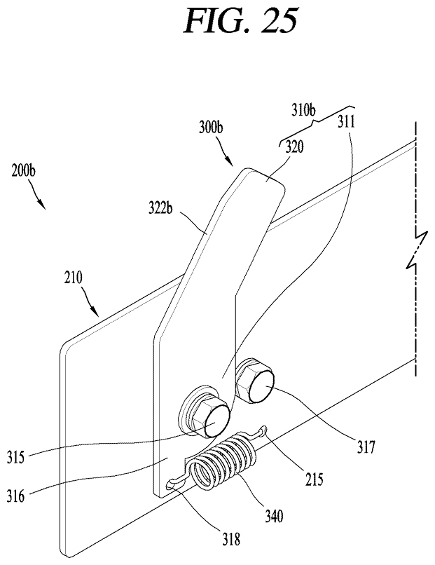

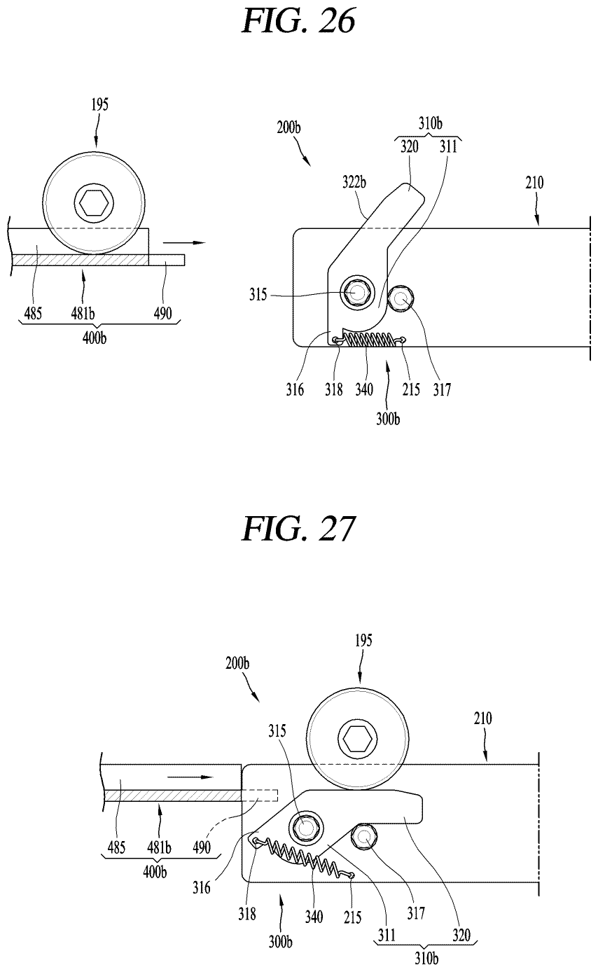

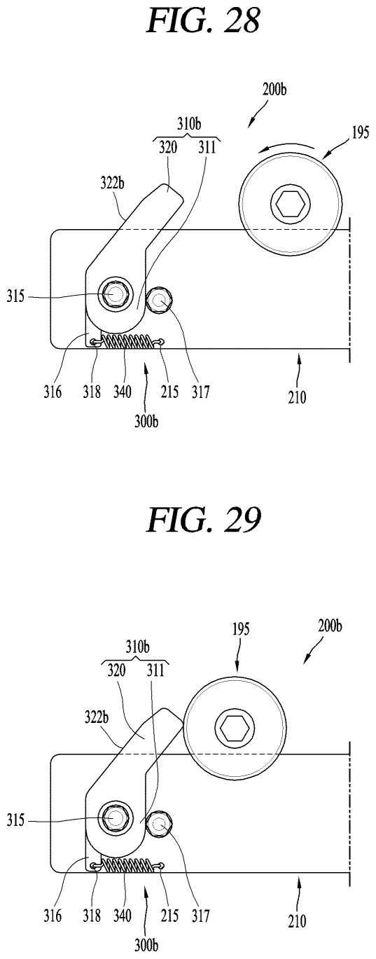

FIG. 25 is a drawing showing an interlock device area of a circuit breaker guide rail according to still another embodiment of the present disclosure, FIG. 26 is a drawing showing a state prior to coupling of the circuit breaker guide rail and the lifter in FIG. 25, FIG. 27 is a drawing showing a permitted location between the wheel of the circuit breaker and the interlock device in FIG. 26, FIG. 28 is a drawing showing an inhibition location between the wheel of the circuit breaker and the interlock device in FIG. 27, and FIG. 29 is a drawing for explaining an operation between the wheel of the circuit breaker and the interlock device in FIG. 28.

As shown in FIG. 25, a circuit breaker guide rail 200b of this embodiment is configured to include a guide rail body 210 and an interlock device 300b.

The guide rail body 210 includes, as described above, an inner plate 220 and an outer plate 230 that are coupled to each other along a thickness direction, for example.

The guide rail body 210 includes a coupling plate 240 coupled to the enclosure 110.

Meanwhile, the interlock device 300b of this embodiment is configured to include an interlock body 310b arranged at either a permitted location that permits movement of the circuit breaker 150 or an inhibition location that inhibits the movement of the circuit breaker 150.

A configuration of the circuit breaker 150, the lifter 400b and the lifting part 470 is similar to the foregoing configuration, and thus will be replaced with the foregoing description and a detailed description will be omitted.

Meanwhile, the interlock body 310b has a plate shape having the same thickness.

The interlock body 310b includes a plate-shaped main body 311.

The guide rail body 210 is provided with a rotation shaft 315 that rotatably supports the interlock body 310b.

The main body 311 rotates around the rotation shaft 315.

The interlock body 310b includes an inhibition part 320 that protrudes upward from the guide rail body 210 when at the inhibition location to inhibit movement of the circuit breaker 150.

The inhibition part 320 is configured to extend to be inclined from the main body 311.

The inhibition part 320 can be arranged to form an acute angle with respect to the upper surface of the inner plate 220 when at the inhibition location.

The main body 311 faces vertically when at the inhibition location, and the inhibition part 320 is arranged to be inclined upward from the main body 311 to a rear area of the guide rail body 210.

The inhibition part 320 can be configured to be in contact with a point greater than half a height of the wheel 195 of the circuit breaker 150 when it comes into contact with the wheel 195 at the inhibition location.

The inhibition part 320 can be configured, for example, to include a linear section 322b arranged parallel to an upper surface of the guide rail 200 when the interlock body 310b is at the permitted location.

In this embodiment, as shown in FIG. 26, the interlock body 310b can be configured to rotate to the permitted location by the pressing of the wheel 195 of the circuit breaker 150.

The linear section 322b of the interlock body 310b can be configured to be in contact with the wheel 195 (inner wheel 196) of the circuit breaker 150.

As shown in FIG. 26, the linear section 322b is arranged to form an acute angle with respect to the upper surface of the guide rail body 210 when at the inhibition location.

According to this configuration, when the wheel 195 of the circuit breaker 150 comes into contact with the interlock body 310b, a contact between the wheel 195 of the circuit breaker 150 and the interlock body 310b can be smoothly performed.

In addition, a rotation range of the interlock body 310b from the inhibition location to the permitted location can be reduced.

The linear section 322b can be configured to be in rolling contact with the wheel 195 of the circuit breaker 150 at the permitted location, as shown in FIG. 27.

Thereby, the interlock body 310b can be rotated to the permitted location by being pressed by the wheel 195 of the circuit breaker 150.

Meanwhile, the guide rail 200b (guide rail body 210) is provided with the support part 317 in contact with the interlock body 310b to support the interlock body 310b when the interlock body 310b is at the inhibition location.

The support part 317 is formed to protrude from an inner surface of the guide rail body 210.

Specifically, the support part 317 can be configured such that, when the wheel 195 of the circuit breaker 150 and the interlock body 310b (inhibition part 320) come into contact with each other at the inhibition location, the interlock body 310b is inhibited from rotating in a direction away from the permitted location (counterclockwise in the drawing).

The support part 317 can be formed at a point spaced rearward (right in the drawing) compared to the rotation shaft 315 of the guide rail body 210.

The support part 317 can be formed to be in contact with one side (right side in the drawing) of the interlock body 310b.

In this embodiment, the interlock device 300b is configured to include an elastic pressing part 340 that elastically presses the interlock body 310b so as to allow the interlock body 310b to move to the inhibition location.

According to this configuration, an overall size and weight of the interlock body 310b can be configured to be relatively small.

Specifically, for example, in this embodiment, a lower area of the rotation shaft 315 of the interlock body 310b (main body 311) can be formed to have a smaller size compared to the inhibition part 320.

Thereby, a size and weight of the interlock body 310b can be reduced.

The elastic pressing part 340 can be implemented, for example, as a tensile coil spring.

One end of the elastic pressing part 340 can be connected to one side (lower side in the drawing) of the interlock body 310b (main body 311), and the other end of the elastic pressing part 340 can be connected to the guide rail body 210.

The elastic pressing part 340 can be coupled in a tensile state at a predetermined length such that, when initially coupled, a tensile force can be exerted to the extent that the interlock body 310b can be rotated to be arranged at the inhibition location.

Thereby, the interlock body 310b can be rotated to the inhibition location by an elastic force accumulated during tension unless a separate external force is applied.

Thereby, an operational reliability of the interlock device 300b can be improved.

The interlock body 310b can be formed with a connection part 316 to which one end (left end in the drawing) of the elastic pressing part 340 can be connected.

The connection part 316 can be formed to protrude downward from a bottom of the interlock body 310b, for example.

The coupling hole 318 to which one end (left end) of the elastic pressing part 340 is coupled can be formed at the connection part 316 to pass therethrough.

For example, a connection hole 215 can be formed at the guide rail body 210 to which the other end (right end) of the elastic pressing part 340 can be coupled to pass therethrough.

By this configuration, when the circuit breaker 150 is to be put into the enclosure 110, the circuit breaker guide rail 200b is coupled to a front of the enclosure 110.

Next, as shown in FIG. 26, subsequent to mounting the circuit breaker 150 on the lifter 400b, the lifter 400b is moved to a front of the guide rail 200b.

As shown in FIG. 27, the lifter 400b is pressed toward the guide rail 200b so as to allow a front end of the inner plate 220 of the guide rail body 210 to be inserted and coupled to the guide rail body coupling part 490 of the lifter 400b.

Next, when the circuit breaker 150 mounted on the lifter 400b is pressed toward the enclosure 110, the wheel 195 of the circuit breaker 150 coupled to the wheel guide part 485 of the lifter 400b moves to an upper surface of the guide rail body 210 (inner plate 220).

In this case, the interlock body 310b arranged at the inhibition location is rotated to the permitted location by being pressed by the wheel 195 (inner wheel 196) of the circuit breaker 150.

When the wheels 195 of the circuit breaker 150 are all moved to the upper surface of the guide rail body 210, as shown in FIG. 28, the interlock body 310b returns (rotates) to an initial location, which is the inhibition location, by an elastic force of the elastic pressing part 340.

Meanwhile, when an external force is unexpectedly applied to the circuit breaker 150 that has moved to the upper surface of the guide rail 200 and the circuit breaker 150 moves to a front end of the guide rail 200b, as shown in FIG. 29, the movement of the circuit breaker 150 can be inhibited by the inhibition part 320 of the interlock body 310b coming into contact with the wheel 195 of the circuit breaker 150.

Thereby, the circuit breaker 150 can be prevented from being detached from the front end of the guide rail 200b to plunge (fall).

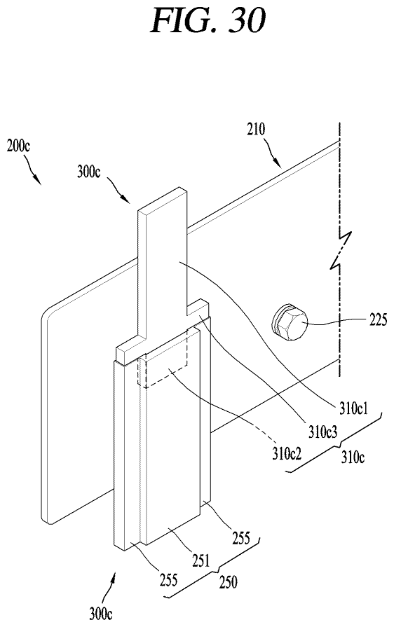

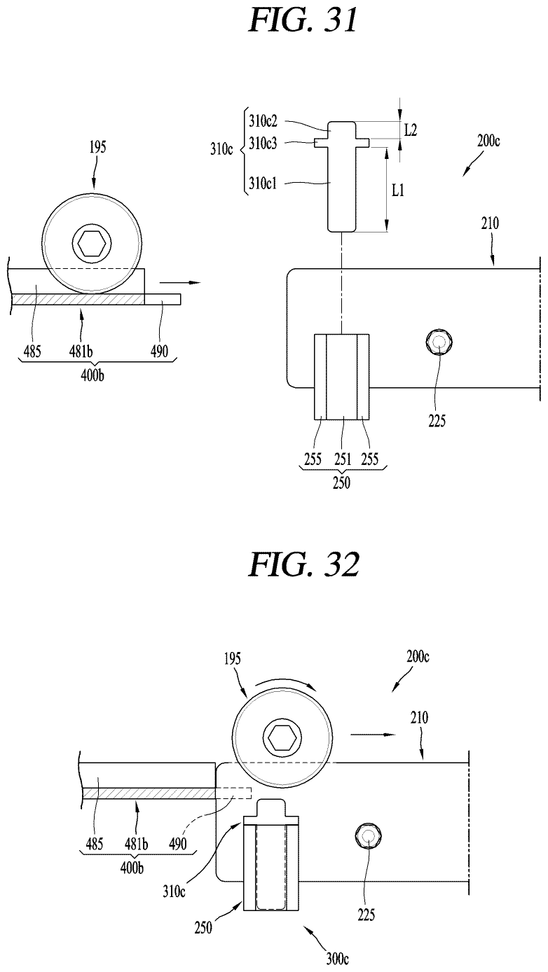

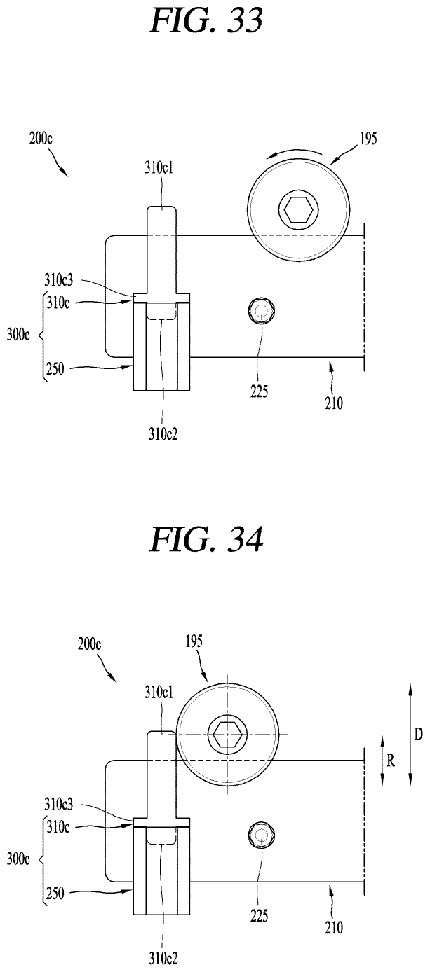

FIG. 30 is a perspective view of an interlock device area of a circuit breaker guide rail according to still another embodiment of the present disclosure, FIG. 31 is a drawing showing a state prior to coupling of the circuit breaker guide rail and the lifter in FIG. 30, FIG. 32 is a drawing showing a permitted location between the wheel of the circuit breaker and the interlock device in FIG. 31, FIG. 33 is a drawing showing an inhibition location between the wheel of the circuit breaker and the interlock device in FIG. 32, and FIG. 34 is a drawing for explaining an operation between the wheel of the circuit breaker and the interlock device in FIG. 33.

As shown in FIG. 30, a circuit breaker guide rail 200c of this embodiment includes a guide rail body 210 and an interlock device 300c.

The guide rail body 210 includes, as described above, an inner plate 220 and an outer plate 230 that are coupled to each other along a thickness direction, for example.

The guide rail body 210 includes a coupling plate 240 coupled to the enclosure 110.

Meanwhile, the interlock device 300c of this embodiment is configured to include an interlock body 310c arranged at either a permitted location that permits movement of the circuit breaker 150 to be put into the enclosure 110 or an inhibition location that inhibits the movement of the circuit breaker 150.

As described above, the circuit breaker guide rail 200c according to this embodiment is provided at a front opening of the enclosure 110.

The circuit breaker 150 can be moved by the lifter 400b that raises and lowers the circuit breaker 150 to correspond to a height of the circuit breaker guide rail 200c.

The lifter 400b, as described above, is configured to include a lifter body 410 provided with a plurality of rollers 450 to be driven, and a lifting part 470 provided to be raised or lowered on the lifter body 410.

The lifting part 470 includes, for example, a car 480 on which the circuit breaker 150 is placed, and a driving part 530 that drives the car 480 to be raised or lowered.

The car 480 includes a plate-shaped base 481b and side walls 483 formed vertically on both sides and rear of the base 481b.

On an upper surface of the base 481b, a wheel guide part 485 is provided that is coupled to the wheel 195 of the circuit breaker 150 to guide movement of the wheel 195.

A guide rail body coupling part 490 is formed on the base 481b of the lifter 400b of this embodiment so as to allow a front end of the guide rail 200 (guide rail body 210) to be coupled thereto.

The guide rail body coupling part 490 is formed from a front end of the wheel guide part 485 to a front end of the base 481b.

The guide rail body coupling part 490 is configured to be cut to a preset length from the front end of the base 481 toward a rear end.

Meanwhile, the guide rail body 210 is provided with an interlock body support part 250 that supports and accommodates the interlock body 310c.

The interlock body support part 250 is provided at a front end of the guide rail body 210.

Specifically, the interlock body support part 250 is provided on an inner surface of a front end of the inner plate 220 of the guide rail body 210.

The interlock body support part 250 can be implemented in a pocket shape having an accommodation space opened in a top-down direction.

The interlock body support part 250 can be configured, for example, to include an interlock body accommodation part 251 into which the interlock body 310c is inserted, and a flange 255 that extends to both sides of the interlock body accommodation part 251 and is in contact with and coupled to the guide rail 200.

The interlock body support part 250 is integrally fixedly coupled to the guide rail body 210.

The flange 255 can be fixedly coupled to the guide rail body 210 by welding or a fastening member.

The interlock body 310c includes, for example, as shown in FIG. 31, a locking part 310c3 that is caught and maintained on an upper surface of the interlock body support part 250, a first body 310c1 that protrudes upward from the locking part 310c3 with a first length, and a second body 310c2 that protrudes from the locking part 310c3 with a second length.

The first body 310c1 and second body 310c2 are configured so as to be respectively inserted and coupled into the interlock body support part 250 along a top-down direction.

The locking part 310c3 is formed to expand along a width direction between the first body 310c1 and the second body 310c2.

The locking part 310c3 can be configured to be caught and maintained on an upper surface of the interlock body support part 250 when the first body 310c1 or the second body 310c2 is inserted and coupled to the interlock body support part 250.

In this embodiment, the interlock body 310c is arranged at a permitted location where the second body 310c2 is arranged below an upper end of the guide rail 200 when the first body 310c1 is inserted into the interlock body support part 250 (see FIG. 32).

The interlock body 310c is arranged at an inhibition location where the first body 310c1 protrudes upward from the guide rail 200 when the second body 310c2 is inserted into the interlock body support part 250 (see FIG. 33).

In this embodiment, the first body 310c1 has, for example, a preset first length L1, and the second body 310c2 has a second length L2 that is shorter compared to the first length.

In this embodiment, the first length L1 can be set to a length such that, when the interlock body 310c is at the inhibition location, an end of the first body 310c1 protrudes upward from the guide rail 200 to inhibit movement of the wheel 195 of the circuit breaker 150, as shown in FIG. 34, for example.

The first length L1 can be set to a length such that the end of the first body 310c1 can correspond to a point greater than half (radius (R)) a height (diameter (D)) of the wheel 195 of the circuit breaker 150.

The second length L2 can be set to a length such that, when the lifter 400b that raises or lowers the circuit breaker 150 is coupled, the end of the second body 310c2 can be arranged on a lower side of the wheel 195 of the circuit breaker 150, as shown in FIG. 32.

Thereby, the circuit breaker 150 mounted on the lifter 400b can be smoothly moved to an upper surface of the guide rail 200.

With this configuration, when the circuit breaker 150 is to be put into the enclosure 110, the circuit breaker guide rails 200c are respectively coupled to a front of the enclosure 110.

Next, as shown in FIG. 31, the circuit breaker 150 to be put into the enclosure 110 is moved using the lifter 400b.

In this case, the interlock body 310c of the interlock device 300c is located at a permitted location at which the first body 310c1 is coupled to the interlock body support part 250, as shown in FIG. 32.

When a front end of the guide rail body 210 is coupled to the guide rail body coupling part 490 of the base 481b of the lifter 400b, the wheel guide part 485 of the base 481b and a front end of the inner plate 220 of the guide rail body 210 come into contact with each other to be aligned in a single line.

Next, when the circuit breaker 150 mounted on the lifter 400b is pressed toward the enclosure 110, the wheel 195 of the circuit breaker 150 coupled to the wheel guide part 485 moves from the wheel guide part 485 to an upper surface of the guide rail body 210.

When the wheels 195 of the circuit breaker 150 all pass through the interlock body 310c and move to the upper surface of the guide rail body 210, the second body 310c2 of the interlock body 310c is inserted and coupled to the interlock body support part 250.

Thereby, the interlock body 310c is arranged at an inhibition location where the first body 310c1 protrudes upward from the guide rail body 210.

Meanwhile, when an external force is unexpectedly applied to the circuit breaker 150 that has moved to an upper surface of the guide rail 200c to allow the circuit breaker 150 to move to a front end of the guide rail 200c, the first body 310c1 of the interlock body 310c comes into contact with the wheel 195 of the circuit breaker 150 to inhibit forward movement of the circuit breaker 150.

Thereby, the circuit breaker 150 can be prevented from being detached from the guide rail 200c to fall.

In the above, specific embodiments of the present disclosure have been shown and described. However, the present disclosure may be implemented in various forms without departing from the concept or gist thereof, and thus the embodiments described above should not be limited to specific contents for carrying out the disclosure.

Furthermore, the foregoing embodiments should be broadly construed within the scope of the technical concept defined by the appended claims even though they are not specifically disclosed in the detailed description herein. Moreover, all changes and modifications within the technical scope of the claims and the equivalent scope thereof should be construed to be included in the appended claims.

1. A circuit breaker guide rail provided at a front of a circuit breaker compartment in which a circuit breaker is accommodated to guide movement of the circuit breaker, the circuit breaker guide rail comprising:
a guide rail body having a rear end coupled to the circuit breaker compartment; and
an interlock device provided at a front end of the guide rail body to control the movement of the circuit breaker placed on an upper surface of the guide rail body,
wherein the interlock device comprises an interlock body arranged at either a permitted location that permits movement of the circuit breaker placed on the upper surface of the guide rail body or an inhibition location that inhibits the movement of the circuit breaker.

2. The circuit breaker guide rail of claim 1, wherein the guide rail body is provided with a rotation shaft that rotatably supports the interlock body, and
wherein a support part is provided on one side of the rotation shaft of the guide rail body to support the interlock body in contact with the interlock body when the interlock body is at the inhibition location.

3. The circuit breaker guide rail of claim 2, wherein the guide rail body comprises:
an inner plate and an outer plate that are in contact with each other in a thickness direction,
wherein the inner plate protrudes upward from the outer plate,
wherein the interlock body is formed to protrude upward from the inner plate when at the inhibition location, and
wherein the interlock body comprises:
an inhibition part protruding upward from the guide rail body when at the inhibition location to inhibit the movement of the circuit breaker.

4. The circuit breaker guide rail of claim 3, wherein the interlock body further comprises:
an expansion part that expands to a larger size compared to the inhibition part so as to be moved to the inhibition location by gravity, and
wherein the inhibition part comprises a linear section arranged parallel to an upper surface of the inner plate when at the permitted location.

5. The circuit breaker guide rail of claim 3, wherein the interlock device further comprises an elastic pressing part that elastically presses the interlock body so as to move the interlock body to the inhibition location.

6. The circuit breaker guide rail of claim 1, wherein the guide rail body is provided with an interlock body support part that accommodates and supports the interlock body, and
wherein when at the inhibition location, the interlock body comprises:
a locking part that is caught and maintained on an upper surface of the interlock body support part;
a first body protruding from the locking part, and protruding upward from the guide rail body to inhibit movement of the circuit breaker; and
a second body protruding from the locking part to be inserted into the interlock body support part.

7. The circuit breaker guide rail of claim 6, wherein the interlock body is formed such that,
when at the permitted location,
the first body is inserted into the interlock body support part, and
the second body protrudes from an upper side of the locking part, but is spaced downward from an upper surface of the guide rail body so as to allow a wheel of the circuit breaker to pass therethrough.

8. The circuit breaker guide rail of claim 1, wherein the guide rail body comprises:
an inner plate and an outer plate that are in contact with each other in a thickness direction, and
wherein the inner plate protrudes upward from the outer plate.

9. The circuit breaker guide rail of claim 8, wherein the interlock body comprises:
an inhibition part protruding upward from the guide rail body, when at the inhibition location, to inhibit the movement of the circuit breaker,
wherein the inhibition part comprises a linear section arranged parallel to an upper surface of the inner plate when at the permitted location,
wherein the linear section is arranged to form an acute angle with respect to the upper surface of the inner plate when at the inhibition location, and
wherein the inhibition part is formed to be in contact with a point greater than half a height of the wheel of the circuit breaker.

10. The circuit breaker guide rail of claim 3, and 8, wherein the guide rail body has a lifter coupling part formed into which a lifter that raises and lowers the circuit breaker is inserted and coupled.

11. The circuit breaker guide rail of claim 10, wherein the lifter coupling part is formed to be cut from a front end of the guide rail body toward the rear end,
wherein the interlock body has a lifter contact part formed so as to be in contact with the lifter, and
wherein the interlock body is pressed by the lifter to rotate to the permitted location.

12. A distribution board comprising:
a circuit breaker;
an enclosure provided with a circuit breaker compartment inside so as to accommodate the circuit breaker; and
a guide rail provided at a front of the enclosure to guide the movement of the circuit breaker,
wherein the guide rail comprises:
a guide rail body having a rear end coupled to the circuit breaker compartment and extending to a front of the enclosure; and
an interlock device comprising an interlock body provided at a front end of the guide rail body, and arranged at either a permitted location that permits movement of the circuit breaker placed on an upper surface of the guide rail body and an inhibition location that inhibits the movement of the circuit breaker.

13. The distribution board of claim 12, wherein the guide rail body comprises:
a rotation shaft that rotatably supports the interlock body; and
a support part in contact with the interlock body to support the interlock body when the interlock body is at the inhibition location.

14. The distribution board of claim 13, wherein the guide rail body comprises:
an inner plate and an outer plate that are in contact with each other in a thickness direction,
wherein the inner plate protrudes upward from the outer plate,
wherein the interlock body is formed to protrude upward from the inner plate,
wherein the circuit breaker is provided with a plurality of wheels, and
wherein the plurality of wheels are each formed to accommodate an upper end of the inner plate.

15. The distribution board of claim 14, wherein the plurality of wheels each comprises an inner wheel and an outer wheel spaced apart along an axial direction,
wherein the inner wheel is arranged on an inner side of the inner plate,
wherein the outer wheel is arranged on an outer side of the inner plate, and
wherein the interlock body comprises:
an inhibition part that protrudes upward from the guide rail body when at the inhibition location to inhibit movement of the circuit breaker; and
an expansion part formed to be significantly expanded compared to the inhibition part so as to be moved to the inhibition location by gravity.

16. The circuit breaker guide rail of claim 4, wherein the guide rail body has a lifter coupling part formed into which a lifter that raises and lowers the circuit breaker is inserted and coupled.

17. The circuit breaker guide rail of claim 5, wherein the guide rail body has a lifter coupling part formed into which a lifter that raises and lowers the circuit breaker is inserted and coupled.

18. The circuit breaker guide rail of claim 8, wherein the guide rail body has a lifter coupling part formed into which a lifter that raises and lowers the circuit breaker is inserted and coupled.
